(19) United States
(12) Patent Application Publication
(10) Pub. No.: US 2021/0324281 A1
(43) Pub. Date: Oct. 21, 2021

(54) FUEL DERIVED FROM RENEWABLE RESOURCES

(71) Applicant: UNIVERSITÄT REGENSBURG, Regensburg (DE)

(72) Inventors: Florian KERKEL, Neutraubling (DE); Werner KUNZ, Regensburg (DE); Didier TOURAUD, Regensburg (DE); Damian BROCK, Bogen (DE)

(21) Appl. No.: 17/263,888

(22) PCT Filed: Jul. 31, 2019
(86) PCT No.: PCT/EP2019/070653

§ 371 Date: Jan. 27, 2021

(30) Foreign Application Priority Data
Aug. 2, 2018 (EP) PCT/EP2018/071035

(51) Int. Cl. C10L 1/185; C10L 1/189; C09K 15/06; C10L 1/18

(52) U.S. Cl. CPC C10L 1/1855; C10L 1/189; C09K 15/06; C10M 105/36; C10L 2230/081; C10L 2230/083; C10L 2200/0469; C10L 1/1802

(57) ABSTRACT

The present invention relates to fuel derived from renewable resources. More specifically, the present invention provides a composition which can be used as a fuel and a mixture which can be added to one or more C₈₋₂₂ fatty acid triglycerides in order to provide a fuel. In particular, the present invention concerns the reduction of decomposition of such fuels due to bacterial growth and oxidation.

### FIELD OF THE INVENTION

The present invention relates to fuel derived from renewable resources. More specifically, the present invention provides a composition which can be used as a fuel and a mixture which can be added to one or more C₈₋₂₂ fatty acid triglycerides in order to provide a fuel. In particular, the present invention concerns the reduction of decomposition of such fuels due to microbial growth or oxidation processes (e.g. autoxidation). More generally, the gist of the present invention is that certain natural antioxidants (or antimicrobials) can be used to prevent bacterial growth in compositions containing C₈₋₂₂ fatty acid triglycerides and/or C₈₋₂₂ fatty acid C₁₋₆ alkyl esters.

### BACKGROUND OF THE INVENTION

Currently, the research on biofuels appeals to companies and research groups due to growing ecological problems all over the world. Among others, efforts of reducing greenhouse gas emissions that are produced during the combustion of fossil fuels are part of those. Since the demand on energy is still growing and the oil reserves are limited or rather difficult to exploit, the development of fuels based on sustainable resources is of great interest.

Unfortunately, many known biofuels exhibit undesired physicochemical properties: On the one hand, biofuels that are based on vegetable oils have impractically high kinematic viscosities at 40° C. (30-40 mm²/s) compared to diesel (2.7 mm²/s). This leads to poor flow and spray behavior as well as reduced atomization of the fuel. Further, ignition problems and incomplete combustions occur, which lead to lower efficiency and higher soot emissions. In addition, the use of vegetable oils increases the freezing point of the fuel, whereby the applicability of the biofuel in cold regions as well as in the aviation sector is restricted.

To solve these problems, further substances, so-called additives, are added to the biofuel. These are usually contrary to the principles of green chemistry and thus not beneficial for the environment. Thus, metal-containing substances like V₂O₅ and MoO₃, for example, are used as biofuel additives to reduce soot emissions. Moreover, organic peroxides are currently utilized to improve the ignition properties. Since ethanol is immiscible with n-alkanes and therefore with fuels like diesel, it leads to problems during application. Therefore, an additional component, namely an emulsifier, which is again contrary to the green chemistry, is necessary to enable the miscibility of both liquids. As the use of environmentally harmful substances as additives for biofuels can only be regarded as a temporary solution, a substantial need for research concerning formulation still persists.

Zare et al. reported on the influence of oxygenated fuels on transient and steady-state engine emissions in Energy, February 2017, 121, pages 841-853.

The heterogeneous catalytic conversion of glycerol to oxygenated fuel additives has been reported by Samoilov et al. in Fuel, May 2016, 172, pages 310-319.

Measurements of the density, viscosity, surface tension, and refractive index of binary mixtures of cetane with solketal have been published by Esteban et al. in Energy Fuels, 2016, 30(9), pages 7452-7459.

Furthermore, nanostructures in clear and homogeneous mixtures of rapeseed oil and ethanol in the presence of green additives have been published by the present inventors in Colloid and Polymer Science, 293 (11), pages 3225-3235.

Goodrum and Eiteman published certain physical properties of low molecular weight triglyerides for the development of bio-diesel fuel models in Bioresource Technology 1996, 56, pages 55-60.

The synthesis of solketal from glycerol and acetone over Amberlyst-46 has been described by Ilgen et al. in Periodica Polytechica Chemical Engineering, 2017, 61(2), pages 144-148.

US 2008/184616 discloses a method of producing biofuel comprising obtaining a biological material, the biological material comprising protein and triglycerides; hydrolyzing the biological material to obtain free amino acids and a biofuel feedstock; and converting the biofuel feedstock to fatty acid esters.

WO 2006/095219 relates to fuel for a diesel engine, comprising more than 60% by weight of a vegetable oil and 1-5% by weight of a vegetable based organic solvent comprising a terpene compound.

GB 2,445,355 relates to a method of producing a fuel comprising, mixing a first bio-fuel with two or more different second fuels in the presence of a co-solvent capable of effecting a substantially single phase solution of the first and second fuels.

EP 2 816 098 discloses the use of a sulphur compound having at least one —C—S—C-bond for reducing the loss in oxidative stability of a lubricating oil composition for the crankcase of an internal combustion engine when the internal combustion engine is fuelled with a biofuel.

Beller et al. reported on certain natural products as biofuels and bio-based chemicals, particularly fatty acids and isoprenoids, in Natural Products Reports 32(10), 2015, pages 1508 to 1526.

Most biofuels containing fatty acid methyl ester (FAME) are labile to oxidation processes, in particular oxidation with atmospheric oxygen (so-called auto-oxidation). Oxidations are undesirable because they significantly degrade the properties of the fuel, such as the viscosity. In order to ensure storage stability of the biofuel, antioxidants are necessary which prevent the oxidation of the fuel over a certain period of time. Synthetic, fuel-soluble antioxidants such as tert-butyl hydroquinone (TBHQ) are frequently discussed in the literature and are also part of commercially available antioxidant mixtures as can be seen from Almeida et al., Fuel, 90(11), pages 3480 to 3484, and at https://www.inachem.de/de/inaAOX.

Another problem that can occur with biofuels is the accumulation of microorganisms that decompose the fuel over time. The reason for this is that significantly more water can accumulate in biofuels than in conventional diesel or gasoline fuels of mineral origin. At higher temperatures, over time (weeks to months) a certain amount of water dissolves, which then settles at lower temperatures as a result of phase separation to the bottom of the tank. Although bacteria and fungi generally cannot survive in pure biofuel, microorganisms can accumulate in the water film at the bottom of the tank. Via the water/fuel interface, they are then able to decompose the fuel and grow in the water. Microorganism degradation results in a change in the properties of the fuel such as an increase in acid number and is thus undesirable. This phenomenon has so far received only very limited attention in the prior art, when compared to the aforementioned oxidative instability as can be seen from Lee et al., Biofouling 2010, 26(6), pages 623 to 635, and Sørensen et al., Bioresource Technology 2011, 102(8), pages 5259 to -5264.

### SUMMARY OF THE INVENTION

The present invention has been made in view of these problems in the prior art. It is an object of the present invention to provide a composition which can be used as a fuel, particularly a biofuel, and not only has kinematic viscosities similar to diesel, exhibits an improved flow rate, spray behavior and higher efficiency and leads to lower soot emissions, more complete combustion and less ignition problems, but also exhibits increased resistance against growth of microorganisms as well as oxidation. Furthermore, the composition according to the present invention, which may be used as a fuel, preferably adheres to the principles of green chemistry, reduces emission of pollutants and does not contain or lead to the emission of environmentally harmful substances.

Conventionally, fatty acid alkyl esters, such as FAME-biodiesel (fatty acid methyl ester), are prepared via the esterification of a vegetable oil with an alcohol, such as methanol, to improve the physicochemical properties of the oil. In this process, glycerol is produced as by-product in a mass ratio of 1:10 to FAME-biodiesel. The transesterification of a generalized triglyceride with methanol to fatty acid methyl esters (FAME) and glycerol can be depicted as follows:

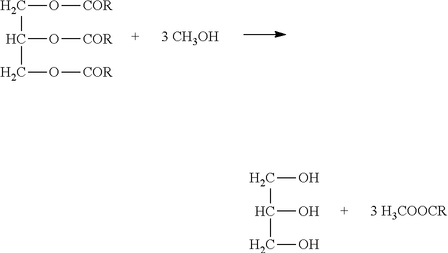

wherein R is usually a C₇₋₂₁ alkyl chain.

Since glycerol is completely immiscible with other fuels and very viscous due to its hydrophilicity, it lacks any application in fuels, which make the huge production volume highly undesirable.

The present inventors have surprisingly found that certain easily accessible glycerol derivatives can be used in preparing biofuels having low viscosities and freezing points. These fuels enable the use of hydrophobic glycerol derivatives at even higher amounts than the amounts in which glycerol is produced during the FAME-biodiesel production. Additionally, the components used in the composition for a biofuel according to the present invention fulfill the principles of green chemistry. The principles of green chemistry have been established by Paul Anastas and are laid down in Anastas, P. T.; Warner, J. C. Green Chemistry: Theory and Practice, Oxford University Press: New York, 1998, p. 30.

The fuel compositions according to the present invention have been thoroughly investigated regarding their ignition, combustion and emission properties and it has been found that they possess surprisingly low emissions compared to other biofuels and even to diesel.

It has been shown by the present inventors that the addition of furan derivatives, especially 2-methylfuran (2-MF), distinctly reduces the kinematic viscosity and freezing temperature of fuels that are based on vegetable oils. 2-Methylfuran can be produced from pentoses on an industrial scale by a few hydrogenation steps, thus making it a completely green synthesis.

The present inventors have furthermore surprisingly found that the use of certain glycerol derivatives, in particular ethers and esters, not only improves miscibility of fatty acid triglycerides with FAME-biodiesel but also leads to improved viscosity of the fuel composition obtained therefrom.

Specific examples of the ethers and esters of glycerol are Solketal (top) and Tributyrin (bottom), the reactions schemes for the production being as follows.

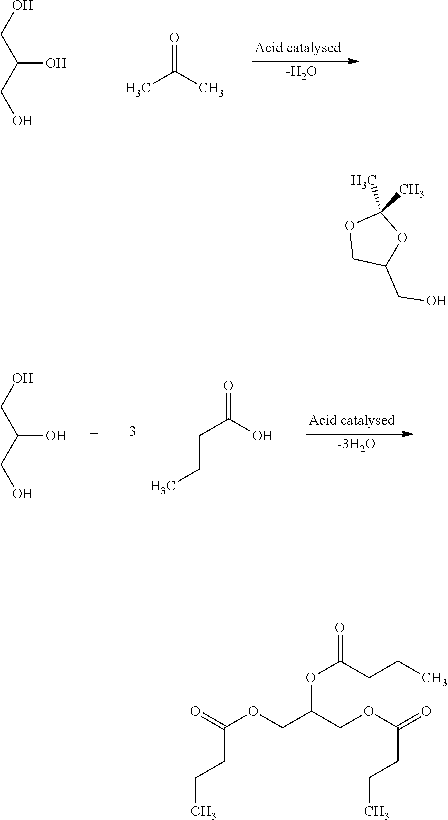

In addition, the present inventors have found that quaternary compositions comprising (a) one or more C₈₋₂₂ fatty acid triglycerides, (b) one or more C₈₋₂₂ fatty acid C₁₋₆ alkyl esters, (c) a furan derivative which is a compound comprising at least one furan moiety or tetrahydrofuran moiety and which comprises from 5 to 15 carbon atoms and from 1 to 10 heteroatoms selected from N, O and S, and (d) a glycerol derivative other than C₈₋₂₂ fatty acid triglycerides exhibit excellent kinematic viscosities, similar to diesel, and exhibit an improved flow rate and spray behavior, higher efficiency and lead to lower soot emissions, more complete combustion and less ignition problems. Furthermore, the fuel compositions according to the present invention may adhere to the principles of green chemistry, reduce emission of pollutants and contain less environmentally harmful substances than known biofuels.

In addition, the present inventors have found that certain natural antioxidants are particularly suitable in preventing oxidation of the compositions and mixtures of the present invention. The present inventors have furthermore found that these antioxidants are suitable for preventing growth of microorganisms in the compositions and mixtures of the present invention as well as other compositions comprising fatty acids. These antioxidants may also adhere to the principles of green chemistry.

The gist of the present invention is that certain natural antioxidants (or antimicrobials) can be used to prevent bacterial growth in compositions containing C₈₋₂₂ fatty acid triglycerides and/or C₈₋₂₂ fatty acid C₁₋₆ alkyl esters. Thus, the present invention relates in its broadest sense to a composition, mixture or formulation containing:
one or more C₈₋₂₂ fatty acid triglycerides and/or one or more C₈₋₂₂ fatty acid C₁₋₆ alkyl esters,
a glycerol derivative other than C₈₋₂₂ fatty acid triglycerides, and
one or more natural antioxidants.

### DESCRIPTION OF THE FIGURES

FIG. 1: Kinematic viscosity versus weight percentage (wt.-%) of rapeseed oil in binary mixtures with Tributyrin (□) and Solketal (∘) at 40° C. The horizontal lines indicate the required viscosity range (from 1.9 to 6.0 mm²/s) according to the ASTM D6751 standard for biodiesel.

FIG. 2: Viscosity and low-temperature measurements of the biofuels consisting of rapeseed oil (R), FAME, 2-MF and constant 10 wt.-% of Solketal (top) and Tributyrin (bottom). The filled measuring points stayed monophasic and clear after one month at 0° C. The encircled compositions were further analysed by engine tests.

FIG. 3: Ignition delay measurements of biofuels, with solketal or tributyrin, and diesel. The combustion start with 5% turnover is shown as a function of the injection pressure and the relative boost pressure.

FIG. 4: Emission measurements of the formulated biofuels, diesel and pure rapeseed oil as a function of the exhaust gas recirculation rate at 200 and 700 mbar relative boost pressure.

FIG. 5: Kinematic viscosity depending on wt.-% of rapeseed oil in mixtures of rapeseed oil and FAME with a constant amount of 30 wt.-% 2-methyl tetrahydrofuran (0), 2,5-dimethyl furan (A) or 2-methyl furan (o) at 40° C. The horizontal lines indicate the viscosity requirements for diesel according to ASTM D6751 (1.9 to 6.0 mm²/s). These are not necessarily applicable to biofuels and only included as a reference. When using 2-methyl furan (o) as the additive, all samples remained liquid under these conditions.

FIG. 6: Combustion processes, injection quantities and burning durations for low and medium load conditions (200 mbar boost pressure and 100 MPa injection pressure as well as 700 mbar boost pressure and 140 MPa injection pressure) without exhaust gas recirculation (top) and with complete exhaust gas recirculation (bottom) of diesel (D), pure rapeseed oil (R) and both formulated biofuels with Tributyrin (B1) and Solketal (B2).

FIG. 7: Kinematic viscosity versus weight percentage (wt.-%) of rapeseed oil in binary mixtures with farnesene, pinene or limonene at 40° C. The horizontal lines indicate the required viscosity range (from 1.9 to 6.0 mm²/s) according to the ASTM D6751 standard for biodiesel.

FIG. 8: Measurements of the oxidative stability of the single, pure components of the biofuels according to DIN EN 16091 and the RapidOxy method. Every sample, for which the pressure dropped by less than 10% compared to its maximum value after 33.3 min, fulfils the standard illustrated by the dashed line.

FIG. 9: Measurements of the oxidative stability of the solketal system with the synthetic antioxidants hydroquinone (HQ) and 2-tert-butylhydroquinone (TBHQ) in different amounts and mass ratios according to the RapidOxy, method. Every sample, for which the pressure dropped by less than 10% compared to its maximum value after 33.3 min, fulfils the standard illustrated by the dashed line.

FIG. 10: Measurements of the oxidative stability of the solketal system with the natural antioxidants gallic acid (GA) and caffeic acid (CA) in mass ratios according to the RapidOxy-method. Every sample, for which the pressure dropped by less than 10% compared to its maximum value after 33.3 min, fulfils the standard illustrated by the dashed line.

FIG. 11: Measured induction times of the solketal system with the natural antioxidants gallic acid (GA) and caffeic acid (CA) as single components and as mixture in a mass ratio of 1:1 versus the concentration of the antioxidants in the mixture according to the RapidOxy-method. Every sample, for which the pressure dropped by less than 10% compared to its maximum value after 33.3 min, fulfils the standard illustrated by the dashed line.

FIG. 12: Measured induction times of the tributyrin system with natural antioxidants. Varying the chain length and the concentration of the alkyl gallates leads to different oxidative stabilities. Every sample, for which the pressure dropped by less than 10% compared to its maximum value after 33.3 min, fulfils the standard illustrated by the dashed line.

FIG. 13: Comparison of the solubilities of hydrophilic antioxidants in glycerol formal (grey) and solketal (white).

FIG. 14: RapidOxy-measurements of a 63/27/10 biodiesel/rapeseed oil/solketal mixture as biofuel (triangle) and the same mixture with the addition of 330 ppm of gallic acid, hydroxytyrosol, quercetin, hydroquinone (HQ) and Cert-butylhydroquinone (TBHQ). The dashed line indicates the European standard for the oxidative stability according to EN 14214.

FIG. 15: RapidOxy-measurements of pure Plantanol (triangle) and Plantanol+500 ppm of the respective antioxidant (i.e. quercetin, hydroxytyrosol, gallic acid, caffeic acid, HQ and TBHQ) in 1 wt.-% of Solketal. The dashed line indicates the European standard for the oxidative stability according to EN 14214.

FIG. 16: RapidOxy-measurements of a 63/27/10 biodiesel/rapeseed oil/solketal mixture as biofuel (triangle) and the same mixture with the addition of 333 ppm of gallic acid, hydroxytyrosol and dihydroxybenzoic acid (DHB). Additionally, 2:1 mixtures of the respective antioxidants (333 ppm) and ascorbic acid (AA) (167 ppm) were prepared. The dashed line indicates the European standard for the oxidative stability according to EN 14214.

FIG. 17: RapidOxy-measurements with different dilutions of oak gall extracts added to the biofuel system 63/27/10 FAME/rapeseed oil/(extract+glycerol formal/solketal). The dashed line indicates the European standard for the oxidative stability according to EN 14214.

FIG. 18: Turbidity measurements of the aqueous phase with Staphylococcus aureus as bacteria culture. “no additive” refers to the incubation of the bacteria solution with pure Plantanol while “medium” refers to the absorbance of the pure bacteria medium pre-incubation.

FIG. 19: Turbidity measurements of the aqueous phase with Escherichia coli as bacteria culture. “no additive” refers to the incubation of the bacteria solution with pure Plantanol while “medium” refers to the absorbance of the pure bacteria medium pre-incubation.

FIG. 20: Turbidity measurements of the aqueous phase with Staphylococcus aureus as bacteria culture. “no additive” refers to the incubation of the bacteria solution with pure Plantanol while “medium” refers to the absorbance of the pure bacteria medium pre-incubation. A 37 wt % formaldehyde (FA) solution was used.

FIG. 21: Turbidity measurements of the aqueous phase with E.-coli as bacteria culture. “no additive” refers to the incubation of the bacteria solution with pure Plantanol while “medium” refers to the absorbance of the pure bacteria medium pre-incubation. A 37 wt % formaldehyde (FA) solution was used.

### DETAILED DESCRIPTION OF THE INVENTION

The present invention provides a composition which can be used as a fuel and a mixture which can be added to one or more fatty acid triglycerides in order to provide a fuel. In the present invention, the term “composition”, relating to the composition according to the invention, may be used interchangeably with “fuel”, “fuel composition” or “biofuel”, unless otherwise indicated.

This fuel composition has kinematic viscosities similar to diesel, exhibits an improved low rate and spray behavior, higher efficiency and leads to lower soot emissions, more complete combustion and less ignition problems. Furthermore, the fuel composition according to the present invention preferably adheres to the principles of green chemistry, reduces emission of pollutants and does not contain or lead to the emission of environmentally harmful substances.

### The Composition

The composition according to the present invention, which is preferably a fuel composition, comprises
one or more C₈₋₂₂ fatty acid triglycerides,
one or more C₈₋₂₂ fatty acid C₁₋₆ alkyl esters,
a glycerol derivative other than C₈₋₂₂ fatty acid triglycerides,
a natural antioxidant,
and optionally
   one or more selected from
   (i) a furan derivative which is a compound comprising at least one furan moiety or tetrahydrofuran moiety and which comprises from 5 to 15 carbon atoms and from 1 to 10 heteroatoms selected from N, O and S, and
   (ii) a terpene derivative selected from monoterpenes and sesquiterpenes and derivatives thereof preferably having the molecular formula C₁₀H₁₆ or O₁₅H₂₄.

The one or more C₈₋₂₂ fatty acid C₁₋₆ alkyl esters preferably comprise one or more C₈₋₁₄ fatty acid C₁₋₆ alkyl esters by at least 70% by weight based on the total weight of all C₈₋₂₂ fatty acid C₁₋₆ alkyl esters.

The fatty acids in the one or more fatty acid triglycerides and the fatty acids in the one or more fatty acid C₁₋₆ alkyl esters are independently selected from one or more carboxylic acids having a number of carbon atoms of 8 to 22.

The glycerol derivative is not a compound containing carboxylic acid residues having a number of carbon atoms of 8 to 22. Preferably, the glycerol derivative is not a compound containing carboxylic acid residues having a number of carbon atoms of 8 or more. Furthermore, the glycerol derivative preferably is not a compound containing carboxylic acid residues having a number of carbon atoms of 0.1 or 2, preferably 1 to 3.

Typically, the composition may comprise more than 0% to 40% by weight of the C₈₋₂₂ fatty acid triglycerides based on the total weight of the composition. Improved results may be obtained if the composition comprises 10% to 30% by weight of the C₈₋₂₂ fatty acid triglycerides based on the total weight of the composition. When not adding any terpenes or furans, the optimal range may be 10 to 15% of the C₈₋₂₂ fatty acid triglycerides based on the total weight of the composition. When adding terpenes and/or furans (e.g. one or both in a total amount of more than 0.01% by weight based on the total weight of the composition), the optimal range may be 20 to 30% of the C₈₋₂₂ fatty acid triglycerides based on the total weight of the composition.

Typically, the composition may comprise 40 to about 95% by weight of the C₈₋₂₂ fatty acid C₁₋₆ alkyl esters based on the total weight of the composition. In order to accommodate a certain amount of C₈₋₂₂ fatty acid triglycerides, an improved composition may comprise 50 to 80% by weight of the C₈₋₂₂ fatty acid C₁₋₆ alkyl esters based on the total weight of the composition. When not adding any terpenes or furans, the optimal range may be 65 to 75% of the C₈₋₂₂ fatty acid C₁₋₆ alkyl esters based on the total weight of the composition. When adding terpenes and/or furans (e.g. one or both in a total amount of more than 0.01% by weight based on the total weight of the composition), the optimal range may be 50 to 60% of the C₈₋₂₂ fatty acid C₁₋₆ alkyl esters based on the total weight of the composition.

Typically, the composition may comprise 1 to 15% by weight of the glycerol derivative other than C₈₋₂₂ fatty acid triglycerides based on the total weight of the composition in order to achieve a preparable balance between improved solubilizing effect for the antioxidant(s) and combustion properties. An improved composition may comprise 2 to 10% by weight of the glycerol derivative other than C₈₋₂₂ fatty acid triglycerides based on the total weight of the composition. 1 to 3% by weight of the glycerol derivative other than C₈₋₂₂ fatty acid triglycerides based on the total weight of the composition may be optimal, in particular if well soluble antioxidants are used. 5 to 10% by weight of the glycerol derivative other than C₈₋₂₂ fatty acid triglycerides based on the total weight of the composition may be optimal for solubilizing any of the antioxidants (including any antimicrobials) disclosed herein.

The amounts of the components in the composition according to the present invention are preferably as follows:

From 10 to 60% by weight of the C₈₋₂₂ fatty acid triglycerides based on the total weight of the composition, preferably from 10 to 50% by weight of the C₈₋₂₂ fatty acid triglycerides based on the total weight of the composition, more preferably from 15 to 40% by weight of the C₈₋₂₂ fatty acid triglycerides based on the total weight of the composition, even more preferably from 20 to 35% by weight of the C₈₋₂₂ fatty acid triglycerides based on the total weight of the composition.

From 35 to 80% by weight of the C₈₋₂₂ fatty acid C₁₋₆ alkyl esters based on the total weight of the composition, preferably from 40 to 70% by weight of the C₈₋₂₂ fatty acid C₁₋₆ alkyl esters based on the total weight of the composition, more preferably from 45 to 65% by weight of the C₈₋₂₂ fatty acid C₁₋₆ alkyl esters based on the total weight of the composition, even more preferably from 55 to 60% by weight of the C₈₋₂₂ fatty acid C₁₋₆ alkyl esters based on the total weight of the composition.

From 0 to 20% by weight of the furan derivative based on the total weight of the composition, in particular from 0.5 to 20% by weight of the furan derivative based on the total weight of the composition, preferably from 0.5 to 10% by weight of the furan derivative based on the total weight of the composition, more preferably from 1 to 10% by weight of the furan derivative based on the total weight of the composition, even more preferably from 1 to 5% by weight of the furan derivative based on the total weight of the composition, still more preferably from 1 to 3% by weight of the furan derivative based on the total weight of the composition.

From 0 to 20% by weight of the terpene derivative based on the total weight of the composition, in particular from 0.5 to 20% by weight of the terpene derivative based on the total weight of the composition, preferably from 0.5 to 10% by weight of the terpene derivative based on the total weight of the composition, more preferably from 1 to 10% by weight of the terpene derivative based on the total weight of the composition, even more preferably from 1 to 5% by weight of the terpene derivative based on the total weight of the composition, still more preferably from 1 to 3% by weight of the terpene derivative based on the total weight of the composition.

From 5 to 20% by weight of the glycerol derivative other than C₈₋₂₂ fatty acid triglycerides based on the total weight of the composition, preferably from 5 to 15% by weight of the glycerol derivative other than C₈₋₂₂ fatty acid triglycerides based on the total weight of the composition, more preferably from 6 to 13% by weight of the glycerol derivative other than C₈₋₂₂ fatty acid triglycerides based on the total weight of the composition, even more preferably from 7 to 12% by weight of the glycerol derivative other than C₈₋₂₂ fatty acid triglycerides based on the total weight of the composition, still more preferably from 8 to 11% by weight of the glycerol derivative other than C₈₋₂₂ fatty acid triglycerides based on the total weight of the composition.

From 0.001 to 5% by weight of the natural antioxidant based on the total weight of the composition, in particular from 0.005 to 2% by weight of the natural antioxidant based on the total weight of the composition, preferably from 0.005 to 1% by weight of the natural antioxidant based on the total weight of the composition, more preferably from 0.01 to 0.5% by weight of the natural antioxidant based on the total weight of the composition, even more preferably from 0.01 to 0.2% by weight of the natural antioxidant based on the total weight of the composition, still more preferably from 0.01 to 0.1% by weight of the natural antioxidant based on the total weight of the composition.

In a preferred embodiment of the composition according to the present invention, the composition comprises, based on the total weight of the composition:
10 to 60% by weight of the one or more C₈₋₂₂ fatty acid triglycerides
35 to 80% by weight of the one or more C₈₋₂₂ fatty acid C₁₋₆ alkyl esters
5 to 20% by weight of the glycerol derivative other than C₈₋₂₂ fatty acid triglycerides
0.001 to 5% by weight of the natural antioxidant, and
optionally 0.5 to 20% by weight of the furan derivative and/or terpene derivative.

In a further preferred embodiment of the composition according to the present invention, the composition comprises, based on the total weight of the composition:
10 to 50% by weight of the one or more C₈₋₂₂ fatty acid triglycerides
40 to 70% by weight of the one or more C₈₋₂₂ fatty acid C₁₋₆ alkyl esters
5 to 15% by weight of the glycerol derivative other than C₈₋₂₂ fatty acid triglycerides
0.005 to 2% by weight of the natural antioxidant, and
optionally 0.5 to 10% by weight of the furan derivative and/or terpene derivative.

In a further preferred embodiment of the composition according to the present invention, the composition comprises, based on the total weight of the composition:
15 to 40% by weight of the one or more C₈₋₂₂ fatty acid triglycerides
45 to 65% by weight of the one or more C₈₋₂₂ fatty acid C₁₋₆ alkyl esters
6 to 13% by weight of the glycerol derivative other than C₈₋₂₂ fatty acid triglycerides
0.005 to 1% by weight of the natural antioxidant, and
optionally 1 to 10% by weight of the furan derivative and/or terpene derivative.

In a further preferred embodiment of the composition according to the present invention, the composition comprises, based on the total weight of the composition:
20 to 35% by weight of the one or more C₈₋₂₂ fatty acid triglycerides
55 to 60% by weight of the one or more C₈₋₂₂ fatty acid C₁₋₆ alkyl esters
7 to 12% by weight of the glycerol derivative other than C₈₋₂₂ fatty acid triglycerides
0.01 to 0.5% by weight of the natural antioxidant, and
optionally 1 to 5% by weight of the furan derivative and/or terpene derivative.

In a further preferred embodiment of the composition according to the present invention, the composition comprises, based on the total weight of the composition:
10 to 40% by weight of the one or more C₈₋₂₂ fatty acid triglycerides
45 to 75% by weight of the one or more C₈₋₂₂ fatty acid C₁₋₆ alkyl esters
1 to 15% by weight of the glycerol derivative other than C₈₋₂₂ fatty acid triglycerides
0.005 to 1% by weight of the natural antioxidant, and
optionally 1 to 10% by weight of the furan derivative and/or terpene derivative.

In a further preferred embodiment of the composition according to the present invention, the composition comprises, based on the total weight of the composition:
15 to 25% by weight of the one or more C₈₋₂₂ fatty acid triglycerides
60 to 75% by weight of the one or more C₈₋₂₂ fatty acid C₁₋₆ alkyl esters
3 to 10% by weight of the glycerol derivative other than C₈₋₂₂ fatty acid triglycerides
0.01 to 0.5% by weight of the natural antioxidant, and
optionally 1 to 5% by weight of the furan derivative and/or terpene derivative.

The composition preferably contains less than 5% by weight ethanol, preferably less than 2% by weight ethanol, more preferably less than 1% by weight ethanol and even more preferably less than 0.5% by weight ethanol based on the total weight of the composition.

When amounts of “the furan derivative and/or terpene derivative” are specified herein, these preferably refer to the total amount of the furan derivative and terpene derivative.

### The Mixture

The mixture according to the present invention preferably differs from the composition according to the present invention in that it contains less than 10% by weight of fatty acid triglycerides based on the total weight of the mixture. This mixture may be provided in the form of an additive which can be added to oils of any origin, preferably vegetable oils, in order to form a fuel composition such as the composition described above. One benefit of this mixture is its suitability for on-site preparation of biofuels by producers of oils. Thereby, fuel costs may be reduced for the consumer and unnecessary transportation efforts can be prevented, thus leading to a more economical and more environmentally friendly fuel.

More specifically, the mixture according to the present invention comprises
one or more C₈₋₂₂ fatty acid C₁₋₆ alkyl esters,
a glycerol derivative other than C₈₋₂₂ fatty acid triglycerides,
one or more natural antioxidants, and optionally one or more selected from
(i) a furan derivative which is a compound comprising at least one furan moiety or tetrahydrofuran moiety and which comprises from 5 to 15 carbon atoms and from 1 to 10 heteroatoms selected from N, O and S, and
(ii) a terpene derivative selected from monoterpenes and sesquiterpenes and derivatives thereof preferably having the molecular formula C₁₀H₁₆ or C₁₅H₂₄.

The one or more C₈₋₂₂ fatty acid C₁₋₆ alkyl esters preferably comprise one or more C₈₋₁₄ fatty acid C₁₋₆ alkyl esters by at least 70% by weight based on the total weight of all C₈₋₂₂ fatty acid C₁₋₆ alkyl esters.

This mixture does not contain more than 10% by weight of C₈₋₂₂ fatty acid triglycerides based on the total weight of the mixture. Preferably, this mixture does not contain 10% or more by weight of C₈₋₂₂ fatty acid triglycerides based on the total weight of the mixture. More preferably, the content of C₈₋₂₂ fatty acid triglycerides based on the total weight of the mixture is not more than 8% by weight, not more than 6% by weight, not more than 4% by weight, not more than 2% by weight, not more than 1% by weight and, most preferably not more than 0.5% by weight.

As used herein the fatty acid triglycerides preferably refer to straight chain carboxylic acids having a number of carbon atoms of 8 to 22 which are either saturated or may have one or more, e.g. 1 to 3, unsaturated C—C double bonds.

The glycerol derivative is not a compound containing carboxylic acid residues having a number of carbon atoms of 8 to 22. Preferably, the glycerol derivative is not a compound containing carboxylic acid residues having a number of carbon atoms of 8 or more. Furthermore, the glycerol derivative preferably is not a compound containing carboxylic acid residues having a number of carbon atoms of 1 or 2, preferably 1 to 3.

The amounts of the components in the mixture according to the present invention are preferably as follows:

From 60 to 95% by weight of the C₈₋₂₂ fatty acid C₁₋₆ alkyl esters based on the total weight of the mixture, preferably from 70 to 90% by weight of the C₈₋₂₂ fatty acid C₁₋₆ alkyl esters based on the total weight of the mixture, more preferably from 75 to 90% by weight of the C₈₋₂₂ fatty acid C₁₋₆ alkyl esters based on the total weight of the mixture, even more preferably from 80 to 90% by weight of the C₈₋₂₂ fatty acid C₁₋₆ alkyl esters based on the total weight of the mixture.

From 0 to 40% by weight of the furan derivative based on the total weight of the mixture, in particular from 0.5 to 40% by weight of the furan derivative based on the total weight of the mixture, preferably from 1 to 20% by weight of the furan derivative based on the total weight of the mixture, more preferably from 2 to 10% by weight of the furan derivative based on the total weight of the mixture, even more preferably from 2 to 6% by weight of the furan derivative based on the total weight of the mixture, still more preferably from 3 to 5% by weight of the furan derivative based on the total weight of the mixture.

From 0 to 40% by weight of the terpene derivative based on the total weight of the mixture, in particular from 0.5 to 40% by weight of the terpene derivative based on the total weight of the mixture, preferably from 1 to 20% by weight of the terpene derivative based on the total weight of the mixture, more preferably from 2 to 10% by weight of the terpene derivative based on the total weight of the mixture, even more preferably from 2 to 6% by weight of the terpene derivative based on the total weight of the mixture, still more preferably from 2 to 5% by weight of the terpene derivative based on the total weight of the mixture.

From 5 to 40% by weight of the glycerol derivative other than C₈₋₂₂ fatty acid triglycerides based on the total weight of the mixture, preferably from 5 to 30% by weight of the glycerol derivative other than C₈₋₂₂ fatty acid triglycerides based on the total weight of the mixture, more preferably from 5 to 25% by weight of the glycerol derivative other than C₈₋₂₂ fatty acid triglycerides based on the total weight of the mixture, even more preferably from 8 to 20% by weight of the glycerol derivative other than C₈₋₂₂ fatty acid triglycerides based on the total weight of the mixture, still more preferably from 10 to 15% by weight of the glycerol derivative other than C₈₋₂₂ fatty acid triglycerides based on the total weight of the mixture.

From 0.002 to 10% by weight of the natural antioxidant based on the total weight of the mixture, in particular from 0.005 to 4% by weight of the natural antioxidant based on the total weight of the mixture, preferably from 0.005 to 2% by weight of the natural antioxidant based on the total weight of the mixture, more preferably from 0.01 to 1% by weight of the natural antioxidant based on the total weight of the mixture, even more preferably from 0.01 to 0.5% by weight of the natural antioxidant based on the total weight of the mixture, still more preferably from 0.01 to 0.2% by weight of the natural antioxidant based on the total weight of the mixture.

In a preferred embodiment of the mixture according to the present invention, the mixture comprises, based on the total weight of the mixture:
60 to 95% by weight of the C₈₋₂₂ fatty acid C₁₋₆ alkyl esters
0.002 to 10% by weight of the natural antioxidant
5 to 40% by weight of the glycerol derivative other than C₈₋₂₂ fatty acid triglycerides, and optionally
0.5 to 40% by weight of the furan derivative and/or terpene derivative.

In a further preferred embodiment of the mixture according to the present invention, the mixture comprises, based on the total weight of the mixture:
70 to 90% by weight of the C₈₋₂₂ fatty acid C₁₋₆ alkyl esters
0.005 to 4% by weight of the natural antioxidant
5 to 30% by weight of the glycerol derivative other than C₈₋₂₂ fatty acid triglycerides, and optionally
1 to 20% by weight of the furan derivative and/or terpene derivative.

In a further preferred embodiment of the mixture according to the present invention, the mixture comprises, based on the total weight of the mixture:
75 to 90% by weight of the C₈₋₂₂ fatty acid C₁₋₆ alkyl esters
0.005 to 2% by weight of the natural antioxidant
5 to 25% by weight of the glycerol derivative other than C₈₋₂₂ fatty acid triglycerides, and optionally
2 to 10% by weight of the furan derivative and/or terpene derivative.

In a further preferred embodiment of the mixture according to the present invention, the mixture comprises, based on the total weight of the mixture:
80 to 85% by weight of the C₈₋₂₂ fatty acid C₁₋₆ alkyl esters
0.01 to 1% by weight of the natural antioxidant
8 to 20% by weight of the glycerol derivative other than C₈₋₂₂ fatty acid triglycerides, and optionally
2 to 6% by weight of the furan derivative and/or terpene derivative.

When amounts of “the furan derivative and/or terpene derivative” are specified herein, these preferably refer to the total amount of the furan derivative and terpene derivative.

The mixture preferably contains less than 5% by weight ethanol, preferably less than 2% by weight ethanol, more preferably less than 1% by weight ethanol and even more preferably less than 0.5% by weight ethanol based on the total weight of the mixture.

### The Formulation

The present invention furthermore relates to a formulation containing one or more C₈₋₂₂ fatty acid triglycerides as defined herein, a glycerol derivative other than C₈₋₂₂ fatty acid triglycerides as defined herein, and one or more natural antioxidants as defined herein.

It is to be understood that the term “formulation” as used herein does not imply any limitations other than the term “composition”. Consequently, the term “composition” may be used instead of “formulation” also for this aspect of the present invention.

The present inventors have surprisingly found that the natural antioxidants disclosed herein are also suitable for ensuring stability of other compositions comprising one or more C₈₋₂₂ fatty acid triglycerides, in particular lubricant formulations or lubricant base oils comprising one or more C₈₋₂₂ fatty acid triglycerides.

The formulation is not particularly limited apart from comprising one or more C₈₋₂₂ fatty acid triglycerides as defined herein, a glycerol derivative other than C₈₋₂₂ fatty acid triglycerides as defined herein, and one or more natural antioxidants as defined herein. It is believed that the glycerol derivative other than C₈₋₂₂ fatty acid triglycerides serves to enable the solubility of the one or more natural antioxidants in the C₈₋₂₂ fatty acid triglycerides.

The formulation preferably does not contain 35% by weight or more of C₈₋₂₂ fatty acid C₁₋₆ alkyl esters based on the total weight of the formulation. More preferably, the content of C₈₋₂₂ fatty acid C₁₋₆ alkyl esters based on the total weight of the formulation is not more than 30% by weight, not more than 25% by weight, not more than 20% by weight, not more than 15% by weight, not more than 10% by weight and, most preferably not more than 2% by weight.

In the case the formulation is a lubricant formulation or lubricant base oil, the further components of the formulation are not particularly limited and may be any components commonly used in lubricating formulations. The skilled person is aware of additional components suitable for lubricant formulations, such as disclosed in US 2019/203152. Accordingly, additives for the lubricant formulation may be chosen, in particular, from among friction modifiers, detergents, antiwear additives, extreme pressure additives, viscosity index improvers, dispersants, antioxidants, pour point improvers, defoamers, thickeners and mixtures thereof, such as disclosed in US 2019/203152.

It is to be understood that the preferred definitions of the one or more C₈₋₂₂ fatty acid triglycerides, a glycerol derivative other than C₈₋₂₂ fatty acid triglycerides, one or more natural antioxidants, etc. as defined in the present application apply also to the formulation. The respective contents of the components of the formulation are preferably as follows:

From 10 to 90% by weight of the C₈₋₂₂ fatty acid triglycerides based on the total weight of the formulation, preferably from 10 to 70% by weight of the C₈₋₂₂ fatty acid triglycerides based on the total weight of the formulation, more preferably from 15 to 40% by weight of the C₈₋₂₂ fatty acid triglycerides based on the total weight of the formulation, even more preferably from 20 to 35% by weight of the C₈₋₂₂ fatty acid triglycerides based on the total weight of the formulation.

From 0 to 20% by weight of the furan derivative based on the total weight of the formulation, in particular from 0.5 to 20% by weight of the furan derivative based on the total weight of the formulation, preferably from 0.5 to 10% by weight of the furan derivative based on the total weight of the formulation, more preferably from 1 to 10% by weight of the furan derivative based on the total weight of the formulation, even more preferably from 1 to 5% by weight of the furan derivative based on the total weight of the formulation, still more preferably from 1 to 3% by weight of the furan derivative based on the total weight of the formulation.

From 0 to 20% by weight of the terpene derivative based on the total weight of the formulation, in particular from 0.5 to 20% by weight of the terpene derivative based on the total weight of the formulation, preferably from 0.5 to 10% by weight of the terpene derivative based on the total weight of the formulation, more preferably from 1 to 10% by weight of the terpene derivative based on the total weight of the formulation, even more preferably from 1 to 5% by weight of the terpene derivative based on the total weight of the formulation, still more preferably from 1 to 3% by weight of the terpene derivative based on the total weight of the formulation.

From 5 to 20% by weight of the glycerol derivative other than C₈₋₂₂ fatty acid triglycerides based on the total weight of the formulation, preferably from 5 to 15% by weight of the glycerol derivative other than C₈₋₂₂ fatty acid triglycerides based on the total weight of the formulation, more preferably from 6 to 13% by weight of the glycerol derivative other than C₈₋₂₂ fatty acid triglycerides based on the total weight of the formulation, even more preferably from 7 to 12% by weight of the glycerol derivative other than C₈₋₂₂ fatty acid triglycerides based on the total weight of the formulation, still more preferably from 8 to 11% by weight of the glycerol derivative other than C₈₋₂₂ fatty acid triglycerides based on the total weight of the formulation.

From 0.001 to 5% by weight of the natural antioxidant based on the total weight of the formulation, in particular from 0.005 to 2% by weight of the natural antioxidant based on the total weight of the formulation, preferably from 0.005 to 1% by weight of the natural antioxidant based on the total weight of the formulation, more preferably from 0.01 to 0.5% by weight of the natural antioxidant based on the total weight of the formulation, even more preferably from 0.01 to 0.2% by weight of the natural antioxidant based on the total weight of the formulation, still more preferably from 0.01 to 0.1% by weight of the natural antioxidant based on the total weight of the formulation.

In a preferred embodiment of the formulation according to the present invention, the formulation comprises, based on the total weight of the formulation:
10 to 90% by weight of the one or more C₈₋₂₂ fatty acid triglycerides,
5 to 20% by weight of the glycerol derivative other than C₈₋₂₂ fatty acid triglycerides, and
0.001 to 5% by weight of the natural antioxidant.

### The One or More Fatty Acid Triglycerides

As used herein, the term “fatty acid” preferably represents a straight chain carboxylic acid having a number of carbon atoms of 8 to 22 which may have one or more, preferably 0 to 3 unsaturated C—C double bonds.

Fatty acids may comprise carboxylic acids naturally found in animal fats, vegetable, and marine oils. They usually consist of long, straight hydrocarbon chains, having 8 to 22 carbon atoms, often 12 to 22 carbon atoms, and include a carboxylic acid group at one end of the molecule. Most natural fatty acids have even numbers of carbon atoms. Fatty acids without double bonds are known as saturated fatty acids, while those with at least one double bond are known as unsaturated fatty acids. The most common saturated fatty acids are palmitic acid (16 carbons) and stearic acid (18 carbons). Oleic and linoleic acid (both having 18 carbons) are the most common unsaturated fatty acids.

As used herein, the term “fatty acid triglycerides” preferably represents glycerol esters of straight chain carboxylic acids having a number of carbon atoms of 8 to 22 which are either saturated or may have one or more, e.g. 1 to 3, unsaturated C—C double bonds, wherein the molar ratio of carboxylic acid residues to glycerol residues is at least 2.5 and preferably 3. In other words, glycerol is preferably esterified with three carboxylic acids. It is to be understood that these three carboxylic acids may be of the same structure or different structures.

The C₈₋₂₂ fatty acid triglycerides are preferably used in the form of commercially available oils or fats which contain these C₈₋₂₂ fatty acid triglycerides or essentially consist of them, e.g. contain at least 98% by weight, more preferably 99% by weight of C₈₋₂₂ fatty acid triglycerides.

The C₈₋₂₂ fatty acid triglycerides may be used in the form of oils or fats which may, e.g., be of animal or vegetable origin. In the present invention, the terms “oil” and “fat” may be used interchangeably.

Common animal fats include lard, duck fat, butter and fats which are obtained from processing meat products, in particular oils and fats from extracting tissue fats obtained from livestock animals such as pigs, chicken and cows.

Vegetable oils or fats include, castor oil, colza oil, coconut oil, cocoa butter, false flax oil from Camelina sativa, palm kernel oil, palm oil, cottonseed oil, wheat germ oil, soybean oil, olive oil, corn oil, sunflower oil, salicornia oil, tigernut oil, tong oil, peanut oil, ramtil oil, mustard oil, safflower oil, hemp oil, grape seed oil, rice bran oil and canola (rapeseed oil), including recycled vegetable oil containing oil of any one or more of these types.

In the present invention, the C₈₋₂₂ fatty acid triglycerides are preferably derived from one or more selected from rapeseed oil, sunflower oil, soybean oil and/or palm oil. In other words, the component comprising the C₈₋₂₂ fatty acid triglycerides preferably comprises one or more selected from rapeseed oil, sunflower oil, soybean oil and/or palm oil. More preferably, the C₈₋₂₂ fatty acid triglycerides are preferably derived from one or more selected from rapeseed oil, sunflower oil, soybean oil and/or palm oil. In other words, the component comprising the C₈₋₂₂ fatty acid triglycerides more preferably comprises one or more selected from rapeseed oil, sunflower oil, soybean oil and/or palm oil.

Typical fatty acid compositions of commercially available oils are given below. These amounts are specified in % by weight based on the weight of all fatty acids. These contents may vary, e.g. may be 20% lower or higher than shown below. Consequently, the contents of the fatty acids in the oil shown below may be within the range of 0.8 times its specified content in % up to 1.2 time the content in %, preferably within the range of 0.9 times its specified content in % up to 1.1 time its specified content in %.

Sunflower oil typically contains 11% saturated fatty acids and 89% unsaturated fatty acids. These include 59% linoleic acid, 30% oleic acid, 6% stearic acid and 5% palmitic acid.

Rapeseed oil typically contains 6% saturated fatty acids and 92% unsaturated fatty acids. These include 56% oleic acid, 26% linoleic acid, 10% linolenic acid, 4% palmitic acid, 2% stearic acid and 2% other fatty acids.

Corn oil 16% typically contains saturated fatty acids and 84% unsaturated fatty acids. These include 52% linoleic acid, 31% oleic acid, 13% palmitic acid, 3% stearic acid and 1% linolenic acid.

Palm oil 48% typically contains saturated fatty acids and 50% unsaturated fatty acids. These include 44% palmitic acid, 40% oleic acid, 10% linoleic acid, 4% stearic acid and 2% other acids.

Unhydrogenated soybean oil typically contains 14% saturated fatty acids and 81% unsaturated fatty acids. These include 51% linoleic acid, 23% oleic acid, 10% palmitic acid, 7% linolenic acid, 4% stearic acid and 5% other fatty acids.

Partially hydrogenated soybean oil typically contains 15% saturated fatty acids and 81% unsaturated fatty acids. These include 43% oleic acid, 35% linoleic acid, 10% palmitic acid, 5% stearic acid, 3% linolenic acid and 4% other fatty acids.

The C₈₋₂₂ fatty acids in the C₈₋₂₂ fatty acid triglycerides preferably comprise 2 to 20%, more preferably 2 to 10% and most preferably 3 to 8% by weight saturated C₈₋₂₂ fatty acids.

The C₈₋₂₂ fatty acids in the C₈₋₂₂ fatty acid triglycerides preferably comprise at least 20%, more preferably at least 30%, even more preferably 40% and most preferably at least 50% by weight oleic acid.

Preferably, the C₈₋₂₂ fatty acids in the C₈₋₂₂ fatty acid triglycerides comprise at least 95% by weight of C₁₆-C₁₈ fatty acids based on the total weight of the C₈₋₂₂ fatty acids in the C₈₋₂₂ fatty acid triglycerides.

### The One or More Fatty Acid C₁₋₆ Alkyl Esters

Conventionally, fatty acid C₁₋₈ alkyl esters such as biodiesel, e.g. fatty acid methyl esters, have been prepared by reacting commercially available oils and fats with alcohols such as methanol. Hence, the one or more C₈₋₂₂ fatty acid C₁₋₆ alkyl esters to be used in the present invention are selected from C₈₋₂₂ fatty acid C₁₋₆ alkyl esters which are obtainable by subjecting any of the C₈₋₂₂ fatty acid triglycerides described herein to transesterification using a C₁₋₆ alkanol. Any descriptions of preferred amounts, compositions and types of C₈₋₂₂ fatty acids as described for the C₈₋₂₂ fatty acid triglycerides are thus also applicable to the C₈₋₂₂ fatty acids in the C₈₋₂₂ fatty acid C₁₋₆ alkyl esters. Preferably, the C₁₋₆ alkanol is ethanol or methanol, more preferably methanol.

The present inventors have, however, surprisingly found that fuel compositions having improved properties may also be obtained if short chain C₈₋₂₂ fatty acid C₁₋₆ alkyl esters are used. These are in particular C₈₋₁₈ carboxylic acids esters with C₁₋₅ alkanols, preferably C₈₋₁₄ carboxylic acid esters with C₁₋₆ alkanols, more preferably C₈₋₁₂ carboxylic acid esters with C₁₋₈ alkanols, even more preferably C₈₋₁₂ carboxylic acid esters with C₁₋₃ alkanols, still more preferably C₈₋₁₂ carboxylic acid esters with methanol and most preferably esters of n-decanoic acid with methanol. Other preferred examples include C₈₋₁₄ carboxylic acid esters with methanol, C₉₋₁₁ carboxylic acid esters with methanol and C₁₀ carboxylic acid esters with methanol. It is to be understood that the C₈₋₂₂ fatty acid C₁₋₆ alkyl esters may also be mixtures of one or more C₈₋₂₂ fatty acid C₁₋₈ alkyl esters. These mixtures preferably contain the C₈₋₁₆ carboxylic acids esters with C₁₋₈ alkanols and the preferred examples thereof in a ratio of at least 50% by weight, based on the total-weight of all C₈₋₂₂ fatty acid C₁₋₆ alkyl esters, more preferably at least 60% by weight, based on the total weight of all C₈₋₂₂ fatty acid C₁₋₆ alkyl esters, even more preferably at least 70% by weight, based on the total weight of all C₈₋₂₂ fatty acid C₁₋₆ alkyl esters, still more preferably at least 80% by weight, based on the total weight of all C₈₋₂₂ fatty acid C₁₋₆ alkyl esters and most preferably at least 90% by weight, based on the total weight of all C₈₋₂₂ fatty acid C₁₋₆ alkyl esters.

The present inventors have surprisingly found that when using such short chain fatty acid alkyl esters, the composition and mixture according to the present invention does not have to contain any furan derivative and/or terpene derivative.

Thus particularly preferable C₈₋₂₂ fatty acid C₁₋₆ alkyl esters are obtainable by reacting cuphea oil with C₁₋₆ alkanols, e.g., methanol or ethanol, more preferably methanol. Cuphea oil typically contains 0.2 to 75% caprylic acid, 0.3 to 97% capric acid, 0.1 to 85% lauric acid, 0.2 to 70% or preferably 0.2 to 10% myristic acid and less than 25%, preferably less than 15%, by weight of other carboxylic acids, based on the total weight of the fatty acids in the cuphea oil.

When using esters of C₈₋₁₄ carboxylic acids with C₁₋₆ alkanols, in particular C₁₋₆ alkyl esters that are obtainable by reacting cuphea oil with C₁₋₆ alkanols, e.g. methanol, the composition of the present invention may even comprise from 10 to 50% by weight of difficult to handle C₈₋₂₂ fatty acid triglycerides, such as rapeseed oil.

### The Furan Derivative

The furan derivative used in the present invention is a compound comprising at least one furan moiety or tetrahydrofuran moiety and which comprises from 5 to 15 carbon atoms and from 1 to 10 heteroatoms selected from N, O and S. It is to be understood that the composition and the mixture may each comprise one or more, preferably 1 to 3 of these furan derivatives.

If more than one furan derivative is used, the amounts specified herein for the furan derivative preferably refer to the total amount of all furan derivatives fulfilling the requirements specified herein, namely comprising at least one furan moiety or tetrahydrofuran moiety and comprising from 5 to 15 carbon atoms and from 1 to 10 heteroatoms selected from N, O and S.

It is to be understood that at least one of the heteroatoms in the furan derivative is oxygen, as both furan and tetrahydrofuran contain an oxygen atom. The furan derivative is preferably a compound comprising from 5 to 15 carbon atoms and from 1 to 5 heteroatoms selected from N, O and S and which comprises at least one furan moiety or tetrahydrofuran moiety. More preferably, the furan derivative is a compound comprising from 5 to 10 carbon atoms and from 1 to 5 heteroatoms selected from N, O and S and which comprises at least one furan moiety or tetrahydrofuran moiety. Even more preferably, the furan derivative is a compound comprising from 5 to 10 carbon atoms and from 1 to 3 heteroatoms selected from N, O and S and which comprises at least one furan moiety or tetrahydrofuran moiety. Still more preferably, the furan derivative is a compound comprising from 5 to 7 carbon atoms and 1 or 2 heteroatoms selected from N, O and S and which comprises at least one furan moiety or tetrahydrofuran moiety. In the furan derivative, the heteroatoms are preferably 0.

More preferably, the furan derivative is one or more selected from the group consisting of C₁₋₆ alkyl furan, di(C₁₋₆ alkyl)furan, C₁₋₆ alkyl tetrahydrofuran and di(C₁₋₆ alkyl)tetrahydrofuran.

Even more preferably, the furan derivative is one or more selected from the group consisting of 2,5-dimethylfuran, 2-methylfuran and 2-methyl tetrahydrofuran.

Most preferably, the furan derivative is 2-methylfuran.

### The Terpene Derivatives

The terpene derivatives are preferably mono- and sesquiterpene derivatives and may be used instead of or in addition to the furan derivative(s) in the present invention.

In the present invention, the term “terpene derivative” comprises terpenes and derivatives thereof. Similarly, the term “mono- and sesquiterpene derivative” comprises mono- and sesquiterpenes and derivatives thereof.

By using these terpene derivatives combustion properties which are even better than in the case of furan derivatives may be achieved. Further, the usage of limonene as fuel compound in our formulations would solve an environmental problem in North Africa and Israel. Due to the fact that these countries cultivate citrus fruits as monoculture in large areas mainly to obtain their juices, the peelings remain as waste. As limonene, which is contained in the peelings, possesses a high aquatic toxicity, the juice producers in these countries face difficulties in disposing limonene without damaging the environment.

Monoterpenes are a class of terpenes that consist of two isoprene units and preferably have the molecular formula C₁₀H₁₆. Similarly, sesquiterpenes are a class of terpenes that consist of three isoprene units and preferably have the molecular formula C₁₅H₂₄. Monoterpenes and sesquiterpenes may be acyclic, e.g. linear or branched, or contain rings, e.g. monocyclic, bicyclic or tricyclic.

The monoterpenes and sesquiterpenes used in the present invention are preferably monocyclic.

Derivatives of mono- and sesquiterpenes include mono- and sesquiterpenes wherein a six-membered ring therein is rendered aromatic, e.g. by replacing three C—C bonds by C═C bonds, thus forming a benzene derivative, and/or wherein one or more unsaturated C═C bonds are hydrogenated and/or wherein one or more C—H group(s) are converted to C—OH group(s). The derivatives of mono- and sesquiterpenes may also be oxygenated mono- and sesquiterpenes, and can thus contain, e.g., one or more acetal group, ether group, ester group and/or carboxylic acid group. These can, for example, be formed by replacing a —CH₂— group in a mono- and sesquiterpene by a —CH₂—O— group, a —CH(OH)— group, a —CH(O—C₁₋₆ alkyl)- group, a —CH(OC(O)(C₁₋₆ alkyl))- group or a —C(O)O— group, and/or by replacing a —CH₃ group by a —CH₂—OH group, a —C(O)OH group, a —C(O)O(C₁₋₆ alkyl) group, a —CH₂O(C₁₋₆ alkyl) group or a —CH₂OC(O)(C₁₋₆ alkyl) group.

Monoterpene hydrocarbons include α-pinene, β-pinene, sabinene, β-myrcene, limonene, Z-β-ocimene and γ-terpinene. Oxygenated monoterpene hydrocarbons include octanal, 1-octanol, linalool oxide, linalool, menthadien-1-ol, trans-p-1,8-dienol, citronellal, α-terpineol, 4-carvon menthenol, α-terpineneol, decanal, Z-carveol, citronellol, carvone, perillaldehyde, isopropyl cresol and 4-vinyl guaiacol. Sesquiterpene hydrocarbons include α-cubebene, copaene, allyl isovalerate, β-cubebene, β-caryophyllene, germacarene, α-farnesene, β-farnesene, γ-munrolene and δ-cadinene. Oxygenated sesquiterpene hydrocarbons include dodecanal, elemol, γ-eudesmol, α-cadinol, β-sinensal, farnesol, α-sinensal and nootkatone.

The mono- and sesquiterpenes to be used in the present invention preferably consist of only carbon atoms and hydrogen atoms and have either the formula C₁₀H₁₆ or C₁₅H₂₄.

Preferred examples of mono- and sesquiterpene derivatives include limonene, farnesene and pinene, in particular, limonene, α-farnesene, β-farnesene, α-pinene and β-pinene. A particularly preferred example of a mono- and sesquiterpene derivative is limonene. A preferred example of limonene is d-limonene.

### The Glycerol Derivative

The term “glycerol derivative” as used herein refers to one or more glycerol derivatives which is/are different from C₈₋₂₂ fatty acid triglycerides, and in particular does not comprise any carboxylic acids residues having a number of carbon atoms of 8 to 22, preferably does not comprise any carboxylic acids residues having a number of carbon atoms of 8 or more, and further preferably does not contain any carboxylic acids residues having a number of carbon atoms of 1 to 2, more preferably 1 to 3. It is to be understood that the composition and the mixture may each comprise one or more, preferably 1 to 3 of these glycerol derivatives.

If more than one glycerol derivative different from C₈₋₂₂ fatty acid triglycerides is used, the amounts specified herein for the “glycerol derivative” preferably refer to the total amount of all glycerol derivatives which are different from C₈₋₂₂ fatty acid triglycerides.

The “glycerol derivative” is preferably selected from glycerol ethers and glycerol esters comprising from 4 to 30 carbon atoms and 3 to 8 oxygen atoms. It is to be understood that these ethers and esters include cyclic ethers and ester. Cyclic ethers are typically compounds including at least one heterocyclic ring with a structural unit [—O—CR₂—O—], wherein each R is preferably independently selected from hydrogen and C₁₋₁₀ alkyl groups. Such cyclic ether may also be referred to as acetals. Cyclic esters may, e.g., be formed by reacting glycerol with a carboxylic acid compound having more than one carboxylic acid group in the molecule.

One preferred type of “glycerol derivatives” is selected from cyclic ethers of glycerol comprising from 4 to 25 carbon atoms and 3 to 6 oxygen atoms, preferably 4 to 18 and 3 to 5 oxygen atoms, more preferably 4 to 12 and 3 or 4 oxygen atoms and most preferably 4 to 7 carbon atoms and 3 oxygen atoms.

In particular when using cyclic ethers of glycerol comprising from 4 to 25 carbon atoms and 3 to 6 oxygen atoms, such as compounds of the following formula (A-I)

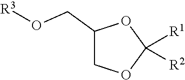

wherein R¹, R² and R³ are each independently selected from hydrogen and C₁₋₁₀ alkyl groups, as a glycerol derivative, it is possible to include up to and including 8 wt-% water, preferably up to and including 5 wt-% water, more preferably 3 to 5 wt-% water, in the composition or mixture of the present invention, based on the total weight of the composition or mixture. The inclusion of more than 5 wt-% can be facilitated by the addition of one or more C₁₋₈ linear, branched or cyclic mono-, di- or trialcohols. It has been found that the addition of water may reduce the amount of oxides of nitrogen in the exhaust gases when combusting fuels containing the composition of the present invention. Without wishing to be bound by theory, it is believed that this reduction in the amount of oxides of nitrogen is brought about by a reduction of combustion temperatures caused by the presence of water. It is surprising that such high amounts of water can be included in the compositions of the present invention if glycerol derivatives as identified above are used. So far, the inclusion of water in an amount of about 5 wt-% or 8 wt-% has only been achievable by the use of large amounts of surfactants which are costly as well as detrimental to the lifetime of the engine and should be avoided in fuel compositions. These problems can thus be overcome by the compositions and mixtures of the present invention, in particular the compositions and mixtures containing the glycerol derivatives, such as solketal, described herein.

Preferably, the “glycerol derivative” may have the following formula (A-I)

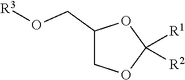

wherein R¹, R² and R³ are each independently selected from hydrogen and C₁₋₁₀ alkyl groups.

More preferably, the “glycerol derivative” may have the following formula (A-II)

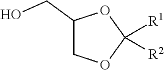

wherein R¹ and R² are each independently selected from hydrogen and C₁₋₁₀ alkyl groups.

In preferred embodiments these groups are C₁₋₈ alkyl groups, C₁₋₆ alkyl groups or C₁₋₄ alkyl groups.

A particularly preferred “glycerol derivative” has the following formula (III) or (IV)

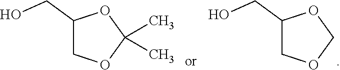

This compound is also known as isopropylideneglycerol and commercially available as Solketal. It may be prepared by reacting glycerol with acetone.

Alternatively, the “glycerol derivative” preferably has the following formula (B-I)

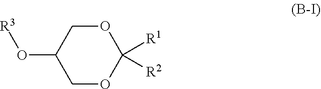

wherein R¹, R² and R³ are each independently selected from hydrogen and C₁₋₁₀ alkyl groups.

More preferably, the “glycerol derivative” may have the following formula (B-II)

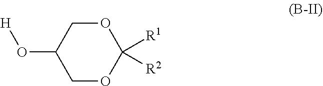

wherein R¹ and R² are each independently selected from hydrogen and C₁₋₁₀ alkyl groups.

It is furthermore preferred that the “glycerol derivative” comprises, or preferably consists of, compounds having the above formulae (B-I) and/or (B-II). The inventors have surprisingly found that such “glycerol derivatives” have surprisingly improved potential for solubilizing one or more of the antioxidants and/or antimicrobials described herein.

In preferred embodiments these groups are C₁₋₈ alkyl groups, C₁₋₆ alkyl groups or C₁₋₄ alkyl groups.

A particularly preferred “glycerol derivative” has the following formula (V) or the following formula (VI)

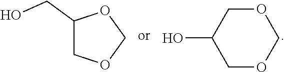 [SMILES: OCC1COCO1 ; OC1COCOC1]

The compounds of formula (V) and formula (VI) are also referred to herein as “glycerol formal(s)”.

It is furthermore preferred that the glycerol derivative other than C₈₋₂₂ fatty acid triglycerides contains, preferably consists of, one or more compounds of the following formulae (A-II) and (B-II)

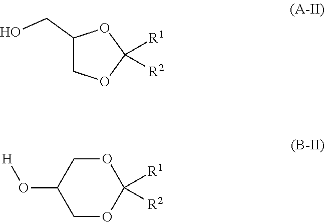

wherein R¹ and R² are either both hydrogen or both methyl.

It is to be understood that the “glycerol derivative” may comprise, or preferably consist of, any mixture of one or more of the examples of “glycerol derivatives” described herein. On the one hand, it is economically worthwhile to use glycerol formal (i.e. compounds of formulae (V) and (VI)) instead of other glycerol derivatives like solketal as the production is cheaper due to the formaldehyde being a cheaper reactant. Acetone, which is used for the synthesis of solketal, for instance, has generally been more than three times more expensive than formaldehyde. In addition, glycerol formal is apparently more hydrophilic than solketal. It is believed that this facilitates the addition of even more hydrophilic antioxidants into the biofuel.

Alternatively, the “glycerol derivative” may be selected from triesters of C₄₋₇ carboxylic acids with glycerol, more preferably triesters of C₄₋₆ carboxylic acids with glycerol and most preferably triesters of C₄ carboxylic acids with glycerol. A preferred example thereof is Tributyrin (glycerol tributyrate).

### The Natural Antioxidants

Biofuels typically have a significant sensitivity toward oxidation by atmospheric oxygen. To prevent this oxidation, antioxidants can be added to the biofuels. On an industrial scale, hydroquinone and its derivatives are commonly used, since they are easily available and inexpensive. Typical examples include hydroquinone (HQ) and 2-tert-butyl hydroquinone (TBHQ).

The term “natural” in “natural antioxidant” generally indicates that the antioxidants are derived from natural resources, typically renewable resources, such as plants, as opposed to antioxidants that are derived from fossil fuels such as natural gas, oil, coal. The term “derived from natural resources” does not necessarily require that the antioxidants as such are actually obtained by mere extraction of natural resources but may also include fully synthetic or partially synthetic compounds that are chemically identical (disregarding any potential differences in isotope composition) to antioxidants that are present in (and can be obtained from) natural resources such as plants. Being derived may thus indicate that the antioxidants can, as such, be extracted from the natural resources or that they can subsequently be modified, e.g. be by one more chemical reactions, such as esterification with linear or branched C₁₋₂₀-alkanol or linear or branched C₁₋₂₀-alkenol.

It is to be understood that the “natural antioxidants” used in the present invention preferably also have antimicrobial activities. The “natural antioxidants” may thus also be referred to as “natural antimicrobials”, “natural antibacterials” and/or “natural antifungals”.

Hydroquinone is classified as carcinogenic, mutagenic and highly aquatoxic and should thus not be used as an additive for biofuels. Nevertheless, the stabilization of biofuels with hydroquinones or even mixtures of natural antioxidants and hydroquinones has been promoted as allegedly green and sustainable. Natural antioxidants have so far only been used in very small amounts compared to the hydroquinones and would thus not have been sufficient in the absence of the hydroquinones.

Since the usage of these toxic compounds did not meet the requirements for the formulation of completely sustainable biofuels, there is an increasing demand for green alternatives to the hydroquinones.

The present inventors have surprisingly found that natural antioxidants, in particular phenolic acids, including esters thereof, and phenolic diterpenes can be used as antioxidants to replace the commonly used hydroquinone. In general, these natural antioxidants may be any compounds comprising 7 to 50 carbon atoms and 3 to 20 heteroatoms selected from N, S and O which contain at least one —OH group attached to a 5 or 6-membered aromatic or partially unsaturated ring, preferably a 6-membered aromatic carbocycle, and preferably a —COOH or —COOR^{G} group, wherein R^{G} is selected from linear or branched C₁₋₂₀-alkyl or linear or branched C₁₋₂₀-alkenyl, wherein the C₁₋₂₀-alkyl or C₁₋₂₀-alkenyl may be substituted with one or more —OH.

Suitable phenolic acids and phenolic diterpenes which can be used as natural antioxidants in the present invention are disclosed in Comprehensive Reviews in Food Science and Food Safety 2011, Vol. 10, pages 221 to 247, which is hereby incorporated in its entirety. Examples of the natural antioxidants that are useful in the present invention and are disclosed in this document are gallic acid, protocatechuic acid, p-coumaric acid, o-coumaric acid, caffeic acid (cis and trans), carnosol, carnosic acid, curcumin, rosmanol, rosmadial, rosmaridiphenol, rosmarinic acid (cis and trans), chlorogenic acid, ferulic acid, ethyl gallate, propyl gallate, octyl gallate, tocopherols such as α-tocopherol, β-tocopherol, γ-tocopherol and δ-tocopherol, epicatechin, quercetin, epicatechin gallate, epigallocatechin gallate, eugenol, carvacrol, safrole, thymol, ascorbic acid, ascorbyl palmitate, resveratrol, syringic acid, sinapinic acid, thymol, vanillic acid, p-hydroxybenzaldehyde, including any esters of these compounds wherein a COOH group is replaced by a —COOR^{G} group, wherein R^{G} is as defined above. Preferred examples are selected from the group consisting of gallic acid, p- and o-coumaric acid, caffeic acid (cis and trans), rosmarinic acid (cis and trans), carnosol, carnosic acid, rosmanol, rosmadial, ethyl gallate, propyl gallate, octyl gallate, tocopherols, epicatechin, eugenol, carvacrol, safrole and thymol and any combination.

Further examples of natural antioxidants that may be used in the present invention include hydroxytyrosol, tyrosol, xanthohumol, arbutin, acetyl salicylic acid, tannic acid, tannins such as corilagin, catechol, myricetin, isoeugenol, sesamol, aesculetin, sorbic acid, methyl 4-hydroxybenzoate, 2,3-dihydroxybenzoic acid, 2,4-dihydroxybenzoic acid, 2,5-dihydroxybenzoic acid, 2,6-dihydroxybenzoic acid, 3,4-dihydroxybenzoic acid 3,5-dihydroxybenzoic acid; including any esters of tannic acid wherein one or more COOH group(s) is/are replaced by a —COOR^{G} group, wherein R^{G} is as defined above.

Tannins are a large group of natural antioxidants including Gallotannins, Ellagitannis, complex tannins and condensed tannins such as described by Khanbabaee et al. in Nat. Prod. Rep., 2001, 18, 641-649. Further tannins are described by Yamada et al. in Molecules, 2018; 23(8), 1901 etc. The tannins disclosed in both references are hereby included by reference in their entirety. Generally, tannins typically contain one or more condensed gallic acid groups and preferably one or more sugar molecules or other non-phenolic hydroxyl groups.

Good effects have been observed with eugenol, carvacrol, thymol, tocopherols, C₂₋₈ alkyl gallates (such as ethyl, propyl, octyl gallate), dihydroxybenzoic acid(s) and curcumin.

Particularly preferred examples of antioxidants (and/or antimicrobials) for use in the present invention are gallic acid, quercetin, tannins, hydroxytyrosol, ferulic acid, sorbic acid, 4-hydroxybenzoic acid, 4-hydroxybenzoic acid and methyl 4-hydroxybenzoate, including any combination or mixture thereof.

For increasing stability against oxidation, combinations of gallic acid+caffeic acid, gallic acid+hydroxyrosol and/or gallic acid+quercetin are particulary preferred.

For achieving both increase stability against oxidation and bacteria, combinations of

a) one or more of gallic acid, quercetin, tannins and hydroxytyrosol, with
b) one or more of ferulic acid, sorbic acid, 4-hydroxybenzoic acid, 4-hydroxybenzoic acid and methyl 4-hydroxybenzoate,
may be used.

The following combinations have been found to be particularly effective:

gallic acid+ferulic acid,
gallic acid+sorbic acid,
gallic acid+4-hydroxybenzoic acid,
gallic acid+methyl 4-hydroxybenzoate.

A further option is gallic acid+methylisothiazolinon.

Further combinations include caffeic acid+hydroxytyrosol, caffeic acid+quercetin, quercetin+hydroxytyrosol. Combinations of gallic acid+Vitamin C or hydroxytyrosol+Vitamin C may also be used.

For a achieving particularly good antibacterial activites, combinations of ferulic acid+methyl 4-hydroxybenzoate an/or ferulic acid+4-hydroxybenzoic acid may be preferable.

The activity of antioxidants can be measured by the recently developed RapidOxy method (M. Garcia et al., Fuel Processing Technology 2017, 156, 407-414), which is the upgrade of the commonly used PetroOxy method (S. Schober and M. Mittellbach; European Journal of Lipid Science and Technology 2004, 106, pages 382-389). In this method, the pressure of a closed, with oxygen filled and afterwards heated sample chamber is measured against time. Regarding the oxidative stability of biofuels, DIN standard DIN EN 16091 must be taken into consideration, which already sets the measuring conditions. Therefore, the samples are heated up to 140° C. with an oxygen pressure of 700 kPa. Since this standard refers to the PetroOxy method and the also suited Rancimat method (L. Botella, et al., Frontiers in Chemistry, 2014, 2, 43-51), there are just empirical investigations regarding the correlation between the results of the Rancimat method and the RapidOxy method. Thus, a biofuel will be stable enough toward oxidation according to the DIN standard if the incubation time is above 33.3 min. The incubation time is the period between the start of the experiment and until the pressure dropped by 10% compared to the maximum pressure in the sample chamber. In FIG. 8 etc., this limit is indicated by a dashed line.

The present inventors found that the following natural antioxidants led to particularly good results in the biofuel formulations of the present invention:

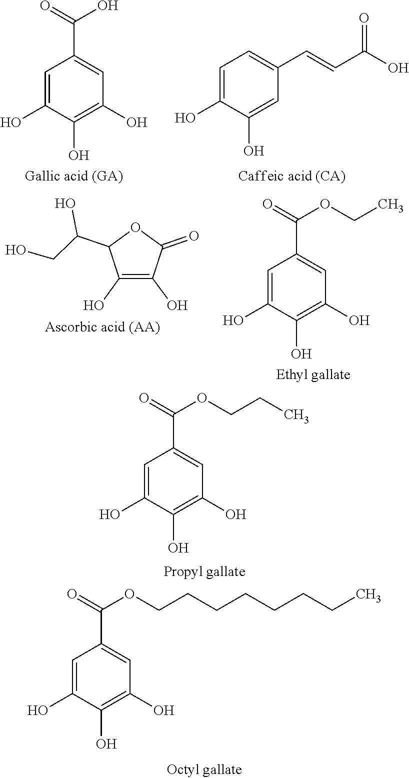 [SMILES: O=C(O)c1cc(O)c(O)c(O)c1 ; O=C(O)/C=C/c1ccc(O)c(O)c1 ; O=C1OC(C(O)CO)C(O)=C1O ; CCOC(=O)c1cc(O)c(O)c(O)c1 ; CCCOC(=O)c1cc(O)c(O)c(O)c1 ; CCCCCCCCOC(=O)c1cc(O)c(O)c(O)c1]

The present inventors found that the suitability of these antioxidants is to some degree dependent on the composition of the biofuels.

In more hydrophobic biofuels, such as biofuels not containing the glycerol derivative of formula (I), the antioxidants are preferably solubilized in the glycerol derivatives first, before adding this mixture to the other fuel components.

In the compositions and mixtures of the present invention C₁₋₂₂ alkyl gallates, preferably C₁₋₈ alkyl gallates such as ethyl gallate, propyl gallate and octyl gallate, are particularly suitable as antioxidants in terms of solubility. Furthermore, C₁₋₂₂ alkyl caffeates, preferably C₁₋₈ alkyl caffeates are expected to provide similar effects in these compositions and mixtures of the present invention.

In compositions and mixtures of the present invention containing the glycerol derivative of formula (I), gallic acid and/or caffeic acid are further preferred examples of antioxidants. Even more preferably, both gallic acid and caffeic acid are comprised in the compositions and mixtures of the present invention containing the glycerol derivative of formula (I). Furthermore, in compositions and mixtures of the present invention containing the glycerol derivative of formula (I), ascorbic acid may be used as an antioxidant in addition to one or more of the gallic acid, caffeic acid, C₁₋₂₂ alkyl gallates and C₁₋₂₂ alkyl caffeates, or in place of these. The present inventors have surprisingly found that in compositions and mixtures of the present invention containing the glycerol derivative, in particular the glycerol derivative of formula (I), ascorbic acid is sufficiently solubilized to be suitable as an antioxidant. The solubility of ascorbic acid can be further improved by using one or more of gallic acid, caffeic acid, C₁₋₂₂ alkyl gallates and C₁₋₂₂ alkyl caffeates. Ascorbic acid is a readily available antioxidant and its use thus not only environmentally but also economically desirable. Its use has, however, so far been limited due to its low solubility in certain biofuels. In the present invention, this drawback has been overcome because even ascorbic acid is rendered soluble by the use of the glycerol derivative, i.e. the glycerol derivative other than C₈₋₂₂ fatty acid triglycerides. This effect is particularly pronounced in the case of the glycerol derivative of formula (I).

Particularly preferred antioxidants for use in the present invention, in particular the compositions and mixtures of the present invention containing the glycerol derivative of formula (I), are mixtures of gallic acid and caffeic acid in a ratio of 2:1 to 1:2, even more preferably 3:2 to 2:3, even more preferably 1:1 and most preferably 1.0:1.0. In particular at combined concentrations of 100 to 300 weight ppm, relative to the entire weight of the composition or mixture of the present invention, these mixtures have been shown to exhibit synergistic effects as compared to the use of only gallic acid or caffeic acid (cf. FIG. 11). These mixtures are preferably used in combination with ascorbic acid, wherein the amount of ascorbic acid is preferably in the range of 0.5 to 100 times the combined amount of gallic acid and caffeic acid.

The natural antioxidants used in the present invention may include or exclude citric acid.

The content of the one or more antioxidants, including mixtures of antioxidants, in compositions and mixtures of the present invention is preferably in the range of 0.005 to 1 wt-%, more preferably 0.01 to 0.5 wt-%, even more preferably 0.01 to 0.2 wt-%, most preferably 0.01 to 0.1 wt-%, based on the entire weight of the composition or mixture of the present invention.

The present inventors have found that the natural antioxidants described herein are not only useful in providing protection against chemical oxidation of the biofuel, or specific components thereof, but can furthermore prevent or delay the decomposition of the biofuel, or specific components thereof, which typically results from bacterial or fungal action.

Microorganisms can grow in biofuels during storage and, thereby, degrade the biofuel, which causes the formation of bio-sludge. The main “problem” of biodiesels in this case is its increased hydrophilicity compared to common diesel/petrol. This enables the increased accumulation of moisture in the fuel during storage. After a certain time, there is enough water at the bottom of the tank for microbes to grow. The bacteria and fungi are then able to survive in the water film and degrade the biofuel at the water/biofuel interface. The degradation of the fuel leads to a significant increase of the viscosity as well as the acid value, which results to clogging of filters and enhanced corrosion, respectively.

The present invention describes the enhancement of certain fuel properties by dissolving hydrophilic additives in the fuel. Hydrophilic antioxidants and bactericides are usually insoluble in biofuels. However, they can be used when including glycerol derivatives as co-solubilisers (so called hydrotropes or “oleotropes”). In contrast to the synthetic antioxidants used in industry, the present invention includes the implementation of natural antioxidants with increased antioxidative activities.

The impact of bactericidal/bacteriostatic compounds added to the biofuel on the bacteria in aqueous medium has been investigated by modifying a commonly used bactericide test, as can be seen from the experimental examples disclosed herein.

The present inventors have furthermore surprisingly found that the high solubility of certain antioxidants in a glycerol derivative could be utilized to extract natural antioxidants from plants (oak gall). Since the extraction solvent represents a potential fuel component, the extract can be directly added to the biofuel without any further work-up (e.g. purification). The direct addition of the extract then achieves a significant increase of the oxidative stability of the biofuel. The present invention thus also relates to the use of extracts of plants, preferably oak gall, which contain gallic acid as additives for biofuels.

The present inventors have surprisingly found that the use of 2-methyl-4-isothiazolin-3-on instead of the natural antioxidant in the compositions and mixtures of the present invention may lead to similar technical effects when adding the glycerol derivative, in particular solketal or glycerol formal, as a solubilizing agent.

### Hydrotreated Vegetable Oils

The compositions and mixtures of the present invention may further comprise other biofuels such as Hydrotreated Vegetable Oils (HVO) (commonly also referred to as renewable diesel) and Hydroprocessed Esters and Fatty Acids (HEFA) which can be produced via hydroprocessing of oils and fats.

HVO and HEFA are straight chain paraffinic hydrocarbons that are preferably free of aromatics, oxygen and sulfur and preferably have high cetane numbers. HEFA offers a number of benefits over FAME (Fatty Acid Methyl Esters), such as reduced NOx emission, better storage stability, and better cold flow properties. Hence HEFA can typically be used in all diesel engines and even its use in aviation fuel is envisaged.

HVO can be produced from a wide variety of materials containing triglycerides and fatty acids. Within this range of materials, HVO is flexible in its feedstock requirements allowing the use of a wide range of low quality waste and residue materials still leading to production of hydrocarbon drop-in products.

Thus, the present invention also relates to the compositions and mixtures comprising one or more Hydrotreated Vegetable Oils and/or Hydroprocessed Esters and Fatty Acids.

### Use of the Composition as a Fuel

The composition according to the present invention can be used directly as a fuel or be combined with other additives before being used as a fuel.

One preferred example of a fuel includes a fuel for a combustion engine, preferably an internal combustion engine. However, it is also envisaged to use the composition according to the present invention in other fuels such as for heating purposes, e.g. in furnaces or boilers in buildings. The composition according to the present invention can be used to replace or be combined with, e.g., gasoline, diesel or kerosene. In particular, the composition according to the present invention can be combined with diesel to produce a fuel comprising the composition according to the invention and diesel. The mixture of the present invention may be used in the same manner.

### Method for Preparing a Fuel

The present invention also relates to a method of preparing a fuel, e.g. a composition according to the invention, which comprises a step of combining the mixture according to the present invention with one or more C₈₋₂₂ fatty acid triglycerides. The definition of the one or more C₈₋₂₂ fatty acid triglycerides is preferably as set out above with respect to the composition of the present invention, including any preferred definitions thereof.

### Definitions

As used herein, the term “composition” describes a combination of two or more components, more specifically, the composition according to the present invention comprises at least the four components as set out in the claims. However, it is to be understood that the composition may comprise any number and amount of other components. Preferably, the composition comprises at least 90% by weight, more preferably 95% by weight and most preferably 99% by weight of the components specified herein (the one or more C₈₋₂₂ fatty acid triglycerides, the one or more C₈₋₂₂ fatty acid C₁₋₆ alkyl esters, the furan derivative and the glycerol derivative), based on the total weight of the composition. Furthermore, it is to be understood that the composition is not limited to containing only one of each of these components and may, e.g. comprise more than one C₈₋₂₂ fatty acid triglyceride, more than one C₈₋₂₂ fatty acid C₁₋₆ alkyl ester, more than one furan derivative and/or more than one glycerol derivative other than the C₈₋₂₂ fatty acid triglycerides.

Similarly, as used herein, the term “mixture” describes a combination of two or more components, more specifically, the mixture according to the present invention comprises at least the three components as set out in the claims. However, it is to be understood that the mixture may comprise any number and amount of other components. Preferably, the mixture comprises at least 90(%) by weight, more preferably 95% by weight and most preferably 99% by weight of the components specified herein (the one or more C₈₋₂₂ fatty acid C₁₋₆ alkyl esters, the furan derivative and the glycerol derivative), based on the total weight of the mixture. Furthermore, it is to be understood that the mixture is not limited to containing only one of each of these components and may, e.g. comprise more than one C₈₋₂₂ fatty acid C₁₋₆ alkyl ester, more than one furan derivative and/or more than one glycerol derivative other than C₈₋₂₂ fatty acid triglycerides.

The expression “composition, mixture or formulation” in present claim 1 is intended to cover the possible areas of application for the natural antimicrobials/antioxidants. Consequently the expression “composition, mixture or formulation” is not intended to imply a limitation other than the requirements that it has to be a composition which contains the components specified in claim 1. As such the expression “composition, mixture or formulation” in claim 1 may also be replaced by the simple term “composition”.

As used herein, the term “alkyl” refers to a monovalent saturated acyclic (i.e., non-cyclic) hydrocarbon group which may be linear or branched. Accordingly, an “alkyl” group does not comprise any carbon-to-carbon double bond or any carbon-to-carbon triple bond. A “C₁₋₆ alkyl” denotes an alkyl group having 1 to 6 carbon atoms. Preferred exemplary alkyl groups are methyl, ethyl, propyl (e.g., n-propyl or isopropyl), or butyl (e.g., n-butyl, isobutyl, sec-butyl, or Cert-butyl). Unless defined otherwise, the term “alkyl” preferably refers to C₁₋₄ alkyl, more preferably to methyl or ethyl, and even more preferably to methyl.

As used herein, the terms “optional”, “optionally” and “may” denote that the indicated feature may be present but can also be absent. Whenever the term “optional”, “optionally” or “may” is used, the present invention specifically relates to both possibilities, i.e., that the corresponding feature is present or, alternatively, that the corresponding feature is absent.

As used herein, the term “one or more” means that not only one but more than one, e.g., two, three or even four or more representatives of the respective component may be included. As an example, the “one or more C₈₋₂₂ fatty acid triglycerides” may represent any oil or fat, e.g. a commercially available oil, such as rapeseed oil, sunflower oil, palm oil, etc., which comprises a large number of C₈₋₂₂ fatty acid triglycerides, or it may be a highly concentrated oil which essentially consists, e.g., contains 95% or more or 98% or more by weight, of one particular C₈₋₂₂ fatty acid triglyceride.

As used herein, the term “natural antioxidant” refers to any naturally occurring compound having antioxidative activity. The term “having antioxidative activity” preferably means, that the compound in an aqueous solution at pH 7 and 25° C. reacts with oxygen (O₂) to form an oxidized compound. Due to this property, the antioxidant is typically able to at least partially prevent the oxidation of other compounds.

As used herein, the term “hydrotreated vegetable oil” refers to any linear or branched C₈₋₂₂ hydrocarbon or mixture of more than one linear or branched C₈₋₂₂ hydrocarbons which are preferably obtained by hydrotreatment of vegetable oil.

It is to be understood that any amounts specified herein in terms of “ppm” refer to “ppm by weight”, except for the experimental examples.

The present invention may be summarized by the following items:

Item 1: A composition, mixture or formulation containing:

one or more C₈₋₂₂ fatty acid triglycerides and/or one or more C₈₋₂₂ fatty acid C₁₋₆ alkyl esters,

a glycerol derivative other than C₈₋₂₂ fatty acid triglycerides, and

one or more natural antioxidants.

Item 2: A composition comprising:

one or more C₈₋₂₂ fatty acid triglycerides

one or more C₈₋₂₂ fatty acid C₁₋₆ alkyl esters

a glycerol derivative other than C₈₋₂₂ fatty acid triglycerides, and

one or more natural antioxidants.

Item 3: The composition according to item 1 or 2, further comprising:

one or more selected from
(i) a furan derivative which is a compound comprising at least one furan moiety or tetrahydrofuran moiety and which comprises from 5 to 15 carbon atoms and from 1 to 10 heteroatoms selected from N, O and S, and
(ii) a terpene derivative selected from monoterpenes and sesquiterpenes and derivatives thereof preferably having the molecular formula C₁₀H₁₆ or C₁₅H₂₄.

Item 4: The composition according to any one of the preceding items, wherein the one or more C₈₋₂₂ fatty acid C₁₋₆ alkyl esters comprise one or more C₈₋₁₄ fatty acid C₁₋₆ alkyl esters by at least 70% by weight based on the total weight of all C₈₋₂₂ fatty acid C₁₋₆ alkyl esters.

Item 5: The composition according to any one of the preceding items, wherein the glycerol derivative is not a compound containing carboxylic acid residues having a number of carbon atoms of 8 or more.

Item 6: The composition according to any one of the preceding items, wherein the glycerol derivative is not a compound containing carboxylic acid residues having a number of carbon atoms of 1 or 2, preferably 1 to 3.

Item 7: The composition according to any one of the preceding items, wherein the composition comprises from 10 to 60% by weight of the C₈₋₂₂ fatty acid triglycerides based on the total weight of the composition, preferably from 10 to 50% by weight of the C₈₋₂₂ fatty acid triglycerides based on the total weight of the composition, more preferably from 15 to 40% by weight of the C₈₋₂₂ fatty acid triglycerides based on the total weight of the composition, even more preferably from 20 to 35% by weight of the C₈₋₂₂ fatty acid triglycerides based on the total weight of the composition.

Item 8: The composition according to any one of the preceding items, wherein the composition comprises from 35 to 80% by weight of the C₈₋₂₂ fatty acid C₁₋₆ alkyl esters based on the total weight of the composition, preferably from 40 to 70% by weight of the C₈₋₂₂ fatty acid C₁₋₆ alkyl esters based on the total weight of the composition, more preferably from 45 to 65% by weight of the C₈₋₂₂ fatty acid C₁₋₆ alkyl esters based on the total weight of the composition, even more preferably from 55 to 60% by weight of the C₈₋₂₂ fatty acid C₁₋₆ alkyl esters based on the total weight of the composition.

Item 9: The composition according to any one of the preceding items, wherein the composition comprises from 0 to 20% by weight of the furan derivative based on the total weight of the composition, in particular from 0.5 to 20% by weight of the furan derivative based on the total weight of the composition, preferably from 0.5 to 10% by weight of the furan derivative based on the total weight of the composition, more preferably from 1 to 10% by weight of the furan derivative based on the total weight of the composition, even more preferably from 1 to 5% by weight of the furan derivative based on the total weight of the composition, still more preferably from 1 to 3% by weight of the furan derivative based on the total weight of the composition.

Item 10: The composition according to any one of the preceding items, wherein the composition comprises from 0 to 20% by weight of the terpene derivative based on the total weight of the composition, in particular from 0.5 to 20% by weight of the terpene derivative based on the total weight of the composition, preferably from 0.5 to 10% by weight of the terpene derivative based on the total weight of the composition, more preferably from 1 to 10% by weight of the terpene derivative based on the total weight of the composition, even more preferably from 1 to 5% by weight of the terpene derivative based on the total weight of the composition, still more preferably from 1 to 3% by weight of the terpene derivative based on the total weight of the composition.

Item 11: The composition according to any one of the preceding items, wherein the composition comprises from 5 to 20% by weight of the glycerol derivative other than the one or more C₈₋₂₂ fatty acid triglycerides based on the total weight of the composition, preferably from 5 to 15% by weight of the glycerol derivative other than the one or more C₈₋₂₂ fatty acid triglycerides based on the total weight of the composition, more preferably from 6 to 13% by weight of the glycerol derivative other than the one or more C₈₋₂₂ fatty acid triglycerides based on the total weight of the composition, even more preferably from 7 to 12% by weight of the glycerol derivative other than the one or more C₈₋₂₂ fatty acid triglycerides based on the total weight of the composition, still more preferably from 8 to 11% by weight of the glycerol derivative other than the one or more C₈₋₂₂ fatty acid triglycerides based on the total weight of the composition.

Item 12: The composition according to any one of the preceding items, wherein the composition comprises from 0.001 to 5% by weight of the natural antioxidant based on the total weight of the composition, in particular from 0.005 to 2% by weight of the natural antioxidant based on the total weight of the composition, preferably from 0.005 to 1% by weight of the natural antioxidant based on the total weight of the composition, more preferably from 0.01 to 0.5% by weight of the natural antioxidant based on the total weight of the composition, even more preferably from 0.01 to 0.2% by weight of the natural antioxidant based on the total weight of the composition, still more preferably from 0.01 to 0.1% by weight of the natural antioxidant based on the total weight of the composition.

Item 13: The composition according to any one of the preceding items, wherein the composition comprises, based on the total weight of the composition:

10 to 60% by weight of the one or more C₈₋₂₂ fatty acid triglycerides

35 to 80% by weight of the one or more C₈₋₂₂ fatty acid C₁₋₆ alkyl esters

5 to 20% by weight of the glycerol derivative other than the one or more C₈₋₂₂ fatty acid triglycerides, and

0.001 to 5% by weight of the natural antioxidant.

Item 14: A mixture comprising

one or more C₈₋₂₂ fatty acid C₁₋₆ alkyl esters,

a glycerol derivative other than C₈₋₂₂ fatty acid triglycerides, and

one or more natural antioxidants,

wherein the mixture does not contain 10% by weight or more of C₈₋₂₂ fatty acid triglycerides based on the total weight of the mixture.

Item 15: The mixture according to item 14, further containing one or more selected from

(i) a furan derivative which is a compound comprising at least one furan moiety or tetrahydrofuran moiety and which comprises from 5 to 15 carbon atoms and from 1 to 10 heteroatoms selected from N, O and S, and
(ii) a terpene derivative selected from monoterpenes and sesquiterpenes and derivatives thereof preferably having the molecular formula C₁₀H₁₆ or C₁₅H₂₄.

Item 16: The mixture according to item 14 or 15, wherein the one or more C₈₋₂₂ fatty acid C₁₋₆ alkyl esters comprise one or more C₈₋₁₄ fatty acid C₁₋₆ alkyl esters by at least 70% by weight based on the total weight of all C₈₋₂₂ fatty acid C₁₋₆ alkyl esters.

Item 17: The mixture according to any one of items 14 to 16, wherein the glycerol derivative is not a compound containing carboxylic acid residues having a number of carbon atoms of 1 or 2, preferably 1 to 3.

Item 18: The mixture according to any one of items 14 to 17, wherein the mixture comprises less than 5% by weight of the C₈₋₂₂ fatty acid triglycerides based on the total weight of the mixture, preferably less than 3% by weight of the C₈₋₂₂ fatty acid triglycerides based on the total weight of the mixture, more preferably less than 1% by weight of the C₈₋₂₂ fatty acid triglycerides based on the total weight of the mixture.

Item 19: The mixture according to any one of items 14 to 18, wherein the mixture comprises from 60 to 95% by weight of the C₈₋₂₂ fatty acid C₁₋₆ alkyl esters based on the total weight of the mixture, preferably from 70 to 90% by weight of the C₈₋₂₂ fatty acid C₁₋₆ alkyl esters based on the total weight of the mixture, more preferably from 75 to 90% by weight of the C₈₋₂₂ fatty acid C₁₋₆ alkyl esters based on the total weight of the mixture, even more preferably from 80 to 90% by weight of the C₈₋₂₂ fatty acid C₁₋₆ alkyl esters based on the total weight of the mixture.

Item 20: The mixture according to any one of items 14 to 19, wherein the mixture comprises from 0 to 40% by weight of the furan derivative based on the total weight of the mixture, in particular from 0.5 to 40% by weight of the furan derivative based on the total weight of the mixture, preferably from 1 to 20% by weight of the furan derivative based on the total weight of the mixture, more preferably from 2 to 10% by weight of the furan derivative based on the total weight of the mixture, even more preferably from 2 to 6% by weight of the furan derivative based on the total weight of the mixture, still more preferably from 2 to 5% by weight of the furan derivative based on the total weight of the mixture.

Item 21: The mixture according to any one of items 14 to 20, wherein the mixture comprises from 0 to 40% by weight of the terpene derivative based on the total weight of the mixture, in particular from 0.5 to 40% by weight of the terpene derivative based on the total weight of the mixture, preferably from 1 to 20% by weight of the terpene derivative based on the total weight of the mixture, more preferably from 2 to 10% by weight of the terpene derivative based on the total weight of the mixture, even more preferably from 2 to 6% by weight of the terpene derivative based on the total weight of the mixture, still more preferably from 2 to 5 by weight of the terpene derivative based on the total weight of the mixture.

Item 22: The mixture according to any one of items 14 to 21, wherein the mixture comprises from 5 to 40% by weight of the glycerol derivative other than C₈₋₂₂ fatty acid triglycerides based on the total weight of the mixture, preferably from 5 to 30% by weight of the glycerol derivative other than C₈₋₂₂ fatty acid triglycerides based on the total weight of the mixture, more preferably from 5 to 25% by weight of the glycerol derivative other than C₈₋₂₂ fatty acid triglycerides based on the total weight of the mixture, even more preferably from 8 to 20% by weight of the glycerol derivative other than C₈₋₂₂ fatty acid triglycerides based on the total weight of the mixture, still more preferably from 10 to 15% by weight of the glycerol derivative other than C₈₋₂₂ fatty acid triglycerides based on the total weight of the mixture.

Item 23: The mixture according to any one of items 14 to 22, wherein the mixture comprises from 0.002 to 10% by weight of the natural antioxidant based on the total weight of the mixture, in particular from 0.005 to 4% by weight of the natural antioxidant based on the total weight of the mixture, preferably from 0.005 to 2% by weight of the natural antioxidant based on the total weight of the mixture, more preferably from 0.01 to 1% by weight of the natural antioxidant based on the total weight of the mixture, even more preferably from 0.01 to 0.5% by weight of the natural antioxidant based on the total weight of the mixture, still more preferably from 0.01 to 0.2% by weight of the natural antioxidant based on the total weight of the mixture.

Item 24: The mixture according to any one of items 14 to 23, wherein the mixture comprises, based on the total weight of the mixture:

60 to 95% by weight of the C₈₋₂₂ fatty acid C₁₋₆ alkyl esters

0.5 to 40% by weight of the furan derivative and/or terpene derivative,

5 to 40% by weight of the glycerol derivative other than C₈₋₂₂ fatty acid triglycerides, and

0.002 to 10% by weight of the natural antioxidant.

Item 25: The composition or mixture according to any one of the preceding items, wherein the C₈₋₂₂ fatty acid triglycerides are derived from rapeseed oil.

Item 26: The composition or mixture according to any one of the preceding items, wherein the C₈₋₂₂ fatty acids in the C₈₋₂₂ fatty acid triglycerides and/or C₈₋₂₂ fatty acid C₁₋₆ alkyl esters comprise 2 to 10% by weight saturated C₈₋₂₂ fatty acids and/or at least 50% by weight oleic acid based on the total weight of the C₈₋₂₂ fatty acids in the C₈₋₂₂ fatty acid triglycerides and/or C₈₋₂₂ fatty acid C₁₋₆ alkyl esters.

Item 27: The composition or mixture according to any one of the preceding items, wherein the C₈₋₂₂ fatty acids in the C₈₋₂₂ fatty acid C₁₋₆ alkyl esters comprise at least 95% by weight fatty acids having 8 to 14 carbon atoms, preferably 8 to 12 carbon atoms, based on the total weight of the C₈₋₂₂ fatty acids in the C₈₋₂₂ fatty acid.

Item 28: The composition or mixture according to any one of the preceding items, wherein the C₈₋₂₂ fatty acids in the C₈₋₂₂ fatty acid C₁₋₆ alkyl esters comprise at least 95% by weight O₈₋₂₂ fatty acids having 9 to 11 carbon atoms, based on the total weight of the C₈₋₂₂ fatty acids in the C₈₋₂₂ fatty acid.

Item 29: The composition or mixture according to any one of the preceding items, wherein the C₈₋₂₂ fatty acid triglycerides are derived from soybean oil and/or palm oil.

Item 30: The composition or mixture according to any one of the preceding items, wherein the C₈₋₂₂ fatty acids in the C₈₋₂₂ fatty acid triglycerides and/or C₈₋₂₂ fatty acid C₁₋₆ alkyl esters comprise at least 95% by weight of C₁₆-C₁₈ fatty acids based on the total weight of the C₈₋₂₂ fatty acids in the C₈₋₂₂ fatty acid triglycerides and/or C₈₋₂₂ fatty acid C₁₋₆ alkyl esters.

Item 31: The composition or mixture according to any one of the preceding items, wherein the C₈₋₂₂ fatty acid C₁₋₆ alkyl esters are methyl or ethyl esters, preferably methyl esters.

Item 32: The composition or mixture according to any one of the preceding items, wherein the composition or mixture contains less than 5% by weight ethanol, preferably less than 2% by weight ethanol, more preferably less than 1% by weight ethanol and even more preferably less than 0.5% by weight ethanol based on the total weight of the composition or mixture.

Item 33: The composition or mixture according to any one of the preceding items, wherein the one or more antioxidants are selected from compounds comprising 7 to 50 carbon atoms and 3 to 20 heteroatoms selected from N, S and O which contain at least one —OH group attached to a 5 or 6-membered aromatic or partially unsaturated ring and preferably a —COOH or —COOR^{G} group, wherein R^{G} is selected from linear or branched C₁₋₂₀-alkyl or linear or branched C₁₋₂₀-alkenyl, wherein the C₁₋₂₀-alkyl or C₁₋₂₀-alkenyl may be substituted with one or more —OH.

Item 34: The composition or mixture according to any one of items 1 to 32, wherein the one or more antioxidants are selected from gallic acid, protocatechuic acid, p-coumaric acid, o-coumaric acid, caffeic acid (cis and trans), carnosol, carnosic acid, curcumin, rosmanol, rosmadial, rosmaridiphenol, rosmarinic acid (cis and trans), chlorogenic acid, ferulic acid, ethyl gallate, propyl gallate, octyl gallate, tocopherols such as α-tocopherol, β-tocopherol, γ-tocopherol and δ-tocopherol, epicatechin, quercetin, epicatechin gallate, epigallocatechin gallate, eugenol, carvacrol, safrole, thymol, ascorbic acid, ascorbyl palmitate, resveratrol, syringic acid, sinapinic acid, thymol, vanillic acid, p-hydroxybenzoic acid, p-hydroxybenzaldehyde, including any esters of these compounds wherein a COOH group is replaced by a —COOR^{G} group, wherein R^{G} is selected from linear or branched C₁₋₂₀-alkyl or linear or branched C₁₋₂₀-alkenyl, wherein the C₁₋₂₀-alkyl or C₁₋₂₀-alkenyl may be substituted with one or more —OH.

Item 35: The composition or mixture according to any one of the preceding items, wherein the total content of the one or more antioxidants is from 0.005 to 1.0 wt-% based on the entire weight of the composition or mixture.

Item 36: The composition or mixture according to any one of items 1 to 32, wherein the one or more antioxidants are selected from gallic acid, caffeic acid, C₁₋₂₂ alkyl esters of gallic acid, C₁₋₂₂ alkyl esters of ascorbic acid and C₁₋₂₂ alkyl esters of caffeic acid.

Item 37: The composition or mixture according to item 36, wherein the antioxidant furthermore comprises ascorbic acid.

Item 38: The composition or mixture according to item 36 or 37, wherein the weight ratio of gallic acid to caffeic acid is in the range of 2:1 to 1:2.

Item 39: The composition or mixture according to item 38, wherein the ratio of ascorbic acid, relative to the combined amount of gallic acid to caffeic acid is 0.5:1 to 100:1.

Item 40: The composition or mixture according to item 39, wherein the content of the antioxidants is from 0.005 to 1.0 wt-% based on the entire weight of the composition or mixture.

Item 41: The composition or mixture according to any one of the preceding items, wherein the composition or mixture comprises the furan derivative.

Item 42: The composition or mixture according to item 41, wherein the furan derivative which is a compound comprising at least one furan moiety or tetrahydrofuran moiety and which comprises from 5 to 15 carbon atoms and from 1 to 10 heteroatoms selected from N, O and S is one or more selected from C₁₋₆ alkyl furan, di(C₁₋₆ alkyl)furan, C₁₋₆ alkyl tetrahydrofuran and di(C₁₋₆ alkyl)tetrahydrofuran.

Item 43. The composition or mixture according to item 42, wherein the furan derivative is one or more selected from 2,5-dimethylfuran, 2-methylfuran and 2-methyl tetrahydrofuran.

Item 44: The composition or mixture according to any one of the preceding items, wherein the composition or mixture comprises the terpene derivative.

Item 45: The composition or mixture according to item 44, wherein the terpene derivative is selected from α-pinene, β-pinene, sabinene, β-myrcene, limonene, Z-β-ocimene, γ-terpinene, α-cubebene, copaene, allyl isovalerate, β-cubebene, β-caryophyllene, germacarene, α-farnesene, β-farnesene, γ-munrolene and δ-cadinene.

Item 46: The composition or mixture according to item 44, wherein the terpene derivative is selected from limonene, α-farnesene, β-farnesene, α-pinene and β-pinene.

Item 47: The composition or mixture according to any one of the preceding items, wherein the glycerol derivative other than C₈₋₂₂ fatty acid triglycerides is selected from glycerol ethers comprising from 4 to 30 carbon atoms.

Item 48: The composition or mixture according to any one of the preceding items, wherein the glycerol derivative other than C₈₋₂₂ fatty acid triglycerides does not contain any C₈₋₂₂ fatty acids comprising more than 7 carbon atoms.

Item 49: The composition or mixture according to any one of the preceding items, wherein the glycerol derivative other than C₈₋₂₂ fatty acid triglycerides is selected from cyclic ethers of glycerol comprising from 4 to 7 carbon atoms.

Item 50: The composition or mixture according to any one of the preceding items, wherein the glycerol derivative other than C₈₋₂₂ fatty acid triglycerides contains, preferably consists of, one or more compounds of the following formulae (A-I) and/or (B-I)

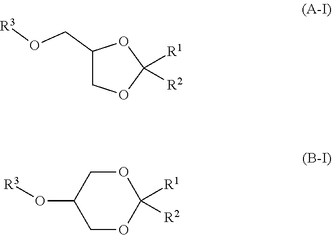

wherein R¹, R² and R³ are each independently selected from hydrogen and C₁₋₁₀ alkyl groups.

Item 51: The composition or mixture according to item 50, wherein the glycerol derivative other than C₈₋₂₂ fatty acid triglycerides contains, preferably consists of, one or more compounds of the following formula (A-II) and/or (B-II)

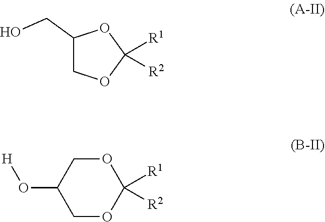

wherein R¹ and R² are each independently selected from hydrogen and C₁₋₁₀ alkyl groups (such as methyl groups).

Item 52: The composition or mixture according to item 51, wherein the glycerol derivative other than C₈₋₂₂ fatty acid triglycerides has the following formula (III)

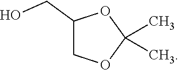

Item 53: The composition or mixture according to item 51, wherein the glycerol derivative other than C₈₋₂₂ fatty acid triglycerides has the following formula (IV)

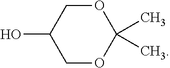

Item 54: The composition or mixture according to item 51, wherein the glycerol derivative other than C₈₋₂₂ fatty acid triglycerides has the following formula (V)

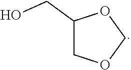

Item 55: The composition or mixture according to item 51, wherein the glycerol derivative other than C₈₋₂₂ fatty acid triglycerides has the following formula (VI)

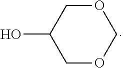

Item 56: The composition or mixture according to item 51, wherein the glycerol derivative other than C₈₋₂₂ fatty acid triglycerides is a mixture of compounds having the following formula (V)

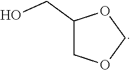

Item and the following formula (VI)

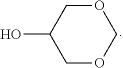

Item 57: The composition, mixture or formulation according to any one of the preceding items, wherein the one or more natural antioxidants is/are selected from gallic acid, protocatechuic acid, p-coumaric acid, o-coumaric acid, caffeic acid (cis and trans), carnosol, carnosic acid, curcumin, rosmanol, rosmadial, rosmaridiphenol, rosmarinic acid (cis and trans), chlorogenic acid, ferulic acid, ethyl gallate, propyl gallate, octyl gallate, tocopherols such as α-tocopherol, β-tocopherol, γ-tocopherol and δ-tocopherol, epicatechin, quercetin, epicatechin gallate, epigallocatechin gallate, eugenol, carvacrol, safrole, thymol, ascorbic acid, ascorbyl palmitate, resveratrol, syringic acid, sinapinic acid, thymol, vanillic acid, p-hydroxybenzoic acid, p-hydroxybenzaldehyde, hydroxytyrosol, tyrosol, xanthohumol, arbutin, acetyl salicylic acid, tannic acid, tannins such as corilagin, catechol, myricetin, isoeugenol, sesamol, aesculetin, sorbic acid, 4-hydroxybenzoic acid, methyl 4-hydroxybenzoate, 2,3-dihydroxybenzoic acid, 2,4-dihydroxybenzoic acid, 2,5-dihydroxybenzoic acid, 2,6-dihydroxybenzoic acid, 3,4-dihydroxybenzoic acid and 3,5-dihydroxybenzoic acid; including any esters of these compounds wherein a COOH group is replaced by a —COOR^{G} group, wherein R^{G} is selected from linear or branched C₁₋₂₀-alkyl or linear or branched C₁₋₂₀-alkenyl, wherein the C₁₋₂₀-alkyl or C₁₋₂₀-alkenyl may be substituted with one or more —OH.

Item 58: The composition, mixture or formulation according to any one of the preceding items, wherein the one or more natural antioxidants is/are

a) one or more of gallic acid, quercetin, tannins and hydroxytyrosol, and/or
b) one or more of ferulic acid, sorbic acid, 4-hydroxybenzoic acid, 4-hydroxybenzoic acid and methyl 4-hydroxybenzoate.

Item 59: The composition or mixture according to any one of the preceding items, wherein the composition or mixture further comprises up to 8 wt-% water, preferably up to 5 wt-% water, based on the total weight of the composition or mixture.

Item 60: The composition or mixture according to any one of the preceding items, wherein the composition or mixture further comprises one or more hydrotreated vegetable oils.

Item 61: The composition or mixture according to any one of the preceding items, wherein 2-methyl-4-isothiazolin-3-on is used instead of, or in addition to, the one or more natural antioxidants.

Item 62: Use of the composition according to any one of items 1 to 13 and 25 to 61 as a fuel.

Item 63. The use according to item 62, wherein the composition is used as a fuel in a combustion engine.

Item 64: A method of preparing a fuel comprising a step of combining a mixture according to any one of items 14 to 61 with one or more C₈₋₂₂ fatty acid triglycerides.

Item 65. The method according to item 64, wherein the fuel is a fuel for use in a combustion engine.

Item 66: An antioxidant composition comprising gallic acid, caffeic acid and ascorbic acid.

Item 67: The antioxidant composition according to item 66, containing less than 5 wt-% water, based on the total weight of the antioxidant composition.

Item 68: The antioxidant composition according to item 66 or 67, containing, based on the total weight of the antioxidant composition, 2 to 40 wt.-% gallic acid, 2 to 40 wt.-% caffeic acid and 20 to 96 wt.-% ascorbic acid.

Item 69: Use of the antioxidant composition according to any one of items 66 to 68 to improve storage stability of a fuel.

Item 70: The use according to item 69, wherein the fuel contains 60 to 95% by weight of C₈₋₂₂ fatty acid C₁₋₆ alkyl esters.

Item 71: A fuel composition comprising:

60 to 95% by weight of C₈₋₂₂ fatty acid C₁₋₆ alkyl esters, and
0.005 to 1% by weight of the antioxidant composition according to any one of items 66 to 68.

Item 72: The fuel composition according to item 71, further containing one or more glycerol derivatives other than C₈₋₂₂ fatty acid triglycerides, as defined herein.

Item 73: An antioxidant composition comprising one or more glycerol formal(s) and tannic acid, characterized in that the composition comprises 50 wt-% or more of the one or more glycerol formal(s) based on the total weight of the composition.

Item 74: The antioxidant composition according to item 73, wherein the antioxidant composition is a plant extract, preferably an extract of oak gall.

Item 75: Use of the antioxidant composition according to item 73 or 74 as the antioxidant in the composition or mixture of any one of items 1 to 61.

Item 76: A formulation comprising:

one or more C₈₋₂₂ fatty acid triglycerides,

a glycerol derivative other than C₈₋₂₂ fatty acid triglycerides, and

one or more natural antioxidants.

Item 77: The formulation according to item 76, wherein the formulation is a lubricant formulation or a lubricant base oil.

It is to be understood that the present invention specifically relates to each and every combination of features and examples described herein, including any combination of general and/or preferred features/examples.

In this specification, a number of documents including patent applications and scientific literature are cited. The disclosure of these documents, while not considered relevant for the patentability of this invention, is herewith incorporated by reference in its entirety. More specifically, all referenced documents are incorporated by reference to the same extent as if each individual document was specifically and individually indicated to be incorporated by reference.

The invention will now be described by reference to the following examples which are merely illustrative and are not to be construed as a limitation of the scope of the present invention.

### Examples

The compounds described in this section are defined by their chemical formulae and their corresponding chemical names. In case of conflict between any chemical formula and the corresponding chemical name indicated herein, the present invention relates to both the compound defined by the chemical formula and the compound defined by the chemical name.

### Part A: Experiments Focusing on Fuel Components

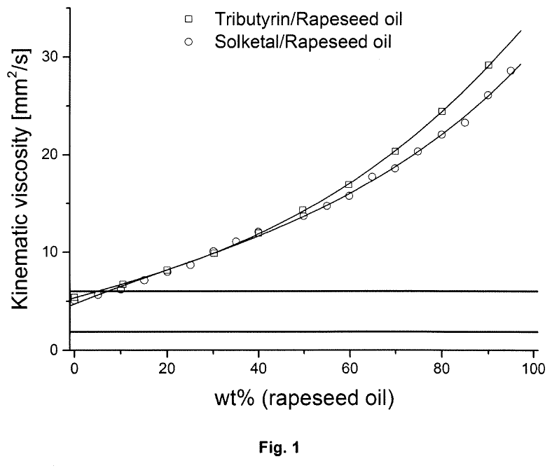

Solketal (isopropylideneglycerol) and Tributyrin (glycerol tributyrate) were used as glycerol derivatives. Both can be synthesized by simple and green addition reactions with acetone or butyric acid as described above. Further, Solketal (ηₖᵢₙₑₘ(40° C.)=5.1 mm²/s and T_{Freeze}=−26.4° C.) as well as Tributyrin (ηₖᵢₙₑₘ(40° C.)=5.4 mm²/s and T_{Freeze}=−75° C.) possess a much lower kinematic viscosity and freezing point than glycerol (ηₖᵢₙₑₘ(40° C.)=270 mm²/s and T_{Freeze}=18° C.). The dynamic viscosities were measured with an automated rolling ball viscometer AMVn from Anton Paar (Graz, Austria). To obtain the abovementioned kinematic viscosities, the density of the samples was determined with a DMA 5000M densitometer from Anton Paar as well. The freezing points were either determined with a cooling thermostat RK 20 from Lauda (Lauda-Konigshofen, Germany) or taken from the manufacturer's specifications. Due to their increased lipophilicity, it has already been shown that ethers and esters of glycerol are miscible with diesel and biodiesel. The formulation of mixtures containing these compounds and pure vegetable oil, while simultaneously fulfilling viscosity standards, was not possible until this point. Surprisingly, the investigation of the miscibility of Solketal and Tributyrin with rapeseed oil and rapeseed oil FAME-biodiesel (FAME, fatty acid methyl esters) showed that in presence of FAME both glycerol derivatives are completely miscible with rapeseed oil at room temperature. Due to their low viscosity, Solketal and Tributyrin are able to reduce the viscosity of rapeseed oil distinctly (see FIG. 1).

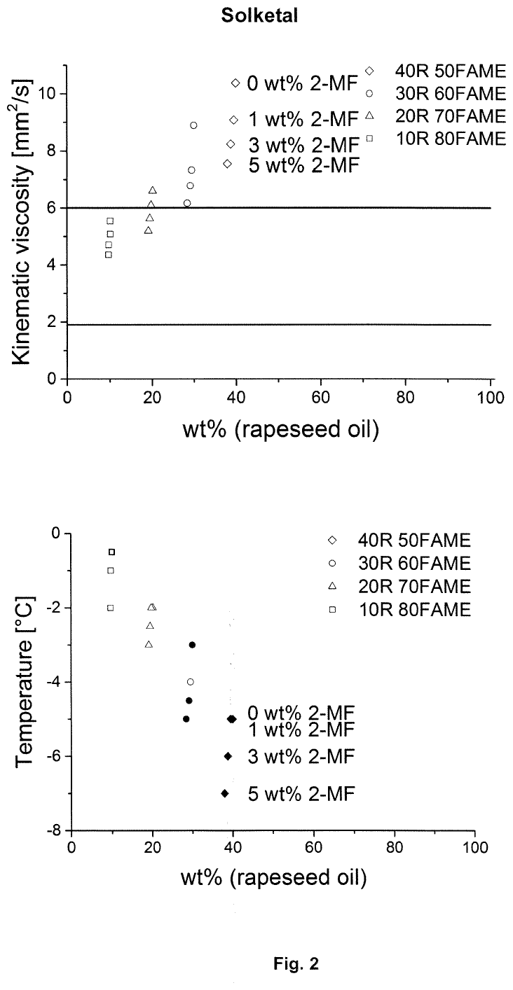

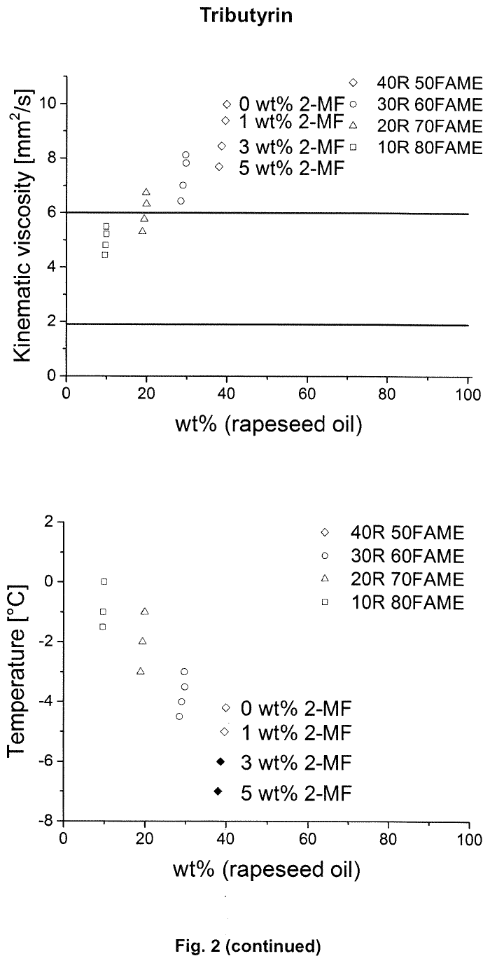

For these formulations, the use of FAME as additional component proved to be reasonable: Since glycerol is mainly produced during FAME production, a direct processing of the glycerol and use of a mixture with FAME would be very profitable. Moreover, FAME is able to reduce the viscosity of the fuel even further and to increase its ignition quality due to its high cetane number. However, it also increases the cloud point of the mixture and that is why an optimal composition needed to be found. After detailed investigations on the ternary mixtures consisting of rapeseed oil, FAME and one of the glycerol derivatives, a few weight percent wt.-%) of 2-MF were added and its influence on the viscosity and cloud point was analyzed as shown in FIG. 2). All ternary mixtures consisted of 10 wt.-% of either Solketal or Tributyrin and 90 wt.-% of a mixture of rapeseed oil and FAME in varying ratios. It was the aim of the formulations to ensure a preferably high amount of rapeseed oil without increasing the viscosity of the mixtures too much. Therefore, 2-MF was added to samples containing 10 to 40 wt.-% of rapeseed oil. FIG. 2 shows that already 1 wt.-% of 2-MF leads to a considerable reduction of the kinematic viscosity. Once there is a certain amount of 2-MF in the mixtures, further additions of 2-MF just slightly change this parameter. Thus, the desired viscosity of the fuel, depending on the application, can be adjusted by using 2-MF. It further illustrates that a fuel containing Tributyrin as glycerol derivative has slightly higher viscosities, but the same progression as the corresponding fuels with Solketal. Similarly to the viscosities, the cloud points can also be reduced by the addition of 2-MF. The black-filled measuring points of FIG. 2 show that the compositions were still monophasic and clear after one month at 0° C. Concerning the cloud points, there is a bigger difference between Solketal and Tributyrin, since the presence of Solketal led to more monophasic samples.

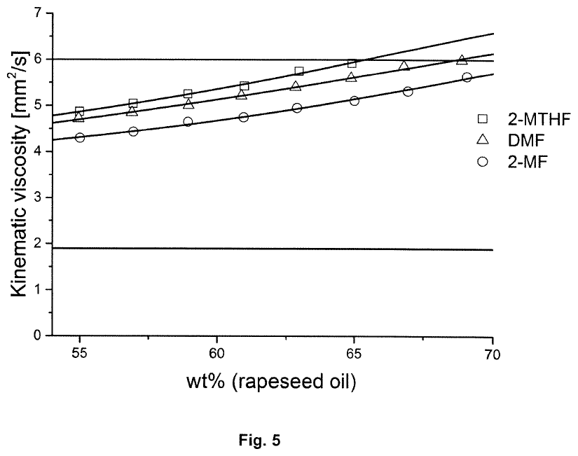

These results are surprising in view of the fact that it had been found that, in the absence of Solketal and Tributyrin, about 20 to 30 wt-% of 2-MF were necessary in compositions containing rapeseed oil and FAME in order to achieve acceptable levels of viscosity and low temperature stability which are comparable to diesel (cf. FIG. 5). Such compositions were however not found to be desirable with respect to combustion properties. From FIG. 5, it can also be seen that the effect of 2-methyl furan, 2-methyl tetrahydrofuran and 2,5-dimethylfuran on the viscosity of the obtained mixtures was comparable, with 2-methyl furan leading to the best results.

Compositions comprising 29.1 wt.-% rapeseed oil, 58.2 wt.-% FAME, 9.7 wt.-% Solketal or Tributyrin and 3.0 wt.-% 2-MF were further analyzed by numerous experiments on an engine test bench. The choice of these mixtures can be explained as follows: With nearly one third of the total formulated biofuel, rapeseed oil is one of the main components, while just a few wt.-% of the additive 2-MF are necessary. Further, the weight ratio between the glycerol derivative and FAME is in both cases 1:6, which is distinctly higher than 1:10 during the biodiesel production. Therefore, the biofuels consist of high amounts of exactly those components that could possibly negatively affect the combustion properties and other properties in the engine tests, namely rapeseed oil and the glycerol derivative. It is thus apparent that the composition according to the present invention can be varied over a wide range without any negative influence on the technical effects. In particular, as these biofuels led to positive results in the engine tests, it can reasonably be assumed that all other possible mixtures with lower amounts of rapeseed oil and the glycerol derivative will exhibit similarly positive results.

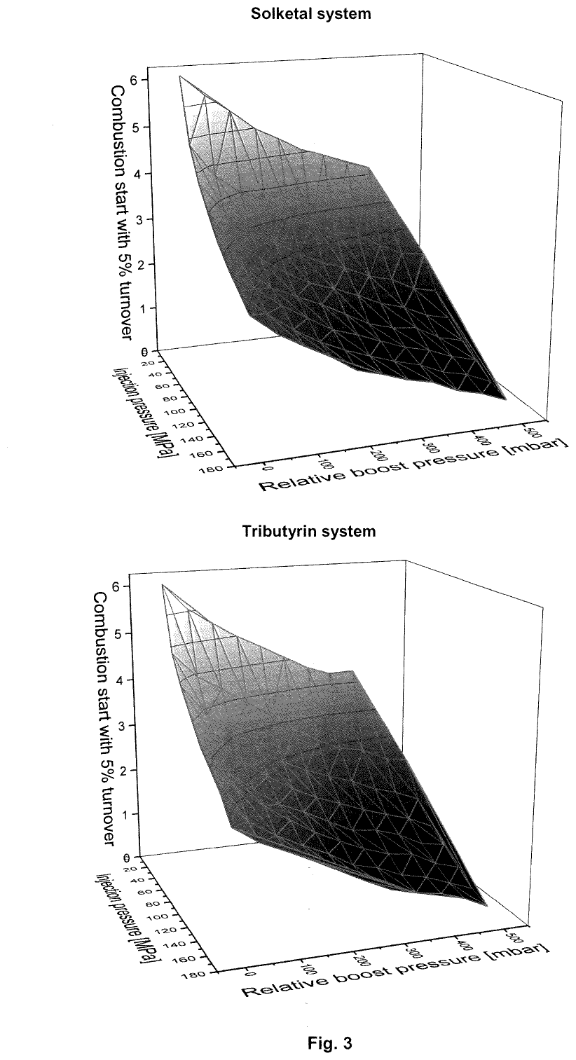

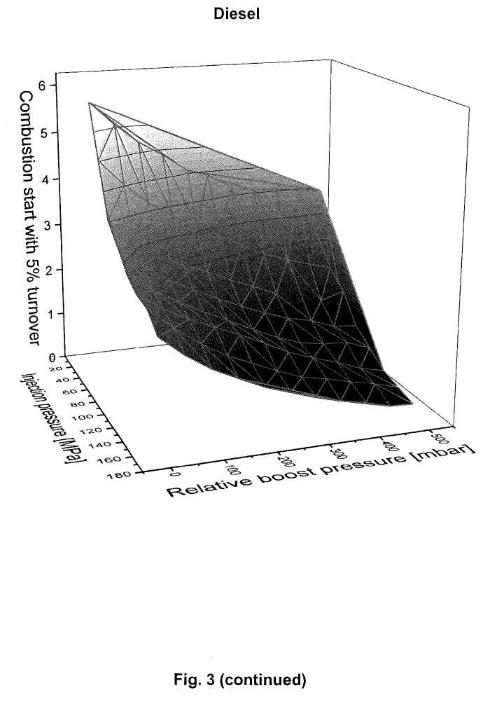

FIG. 3 shows the combustion start as a function of the injection pressure and the relative boost pressure for both formulated biofuels and diesel. By using three-dimensional graphics, it can be seen that, firstly, the Solketal and the Tributyrin system have essentially the same ignition behavior and, secondly, that the formulated biofuels show very similar ignition properties compared to diesel. This implies comparable cetane numbers.

The following considerations should be taken into account in evaluating the properties of biofuels.

The higher the injection and boost pressure, the earlier the combustion start. At very low injection and boost pressures, the combustion start takes slightly longer for the formulated biofuels, but since this time is rapidly decreasing with higher boost pressures, the ignition properties of diesel can be achieved.

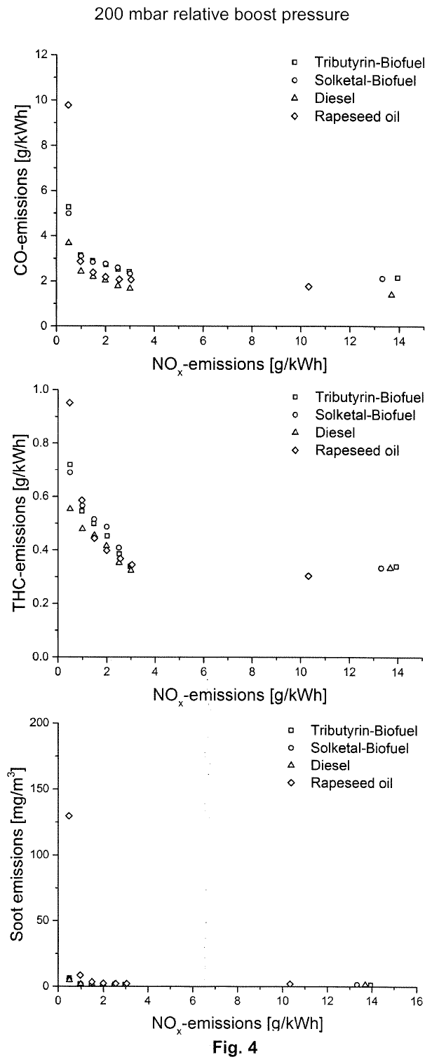

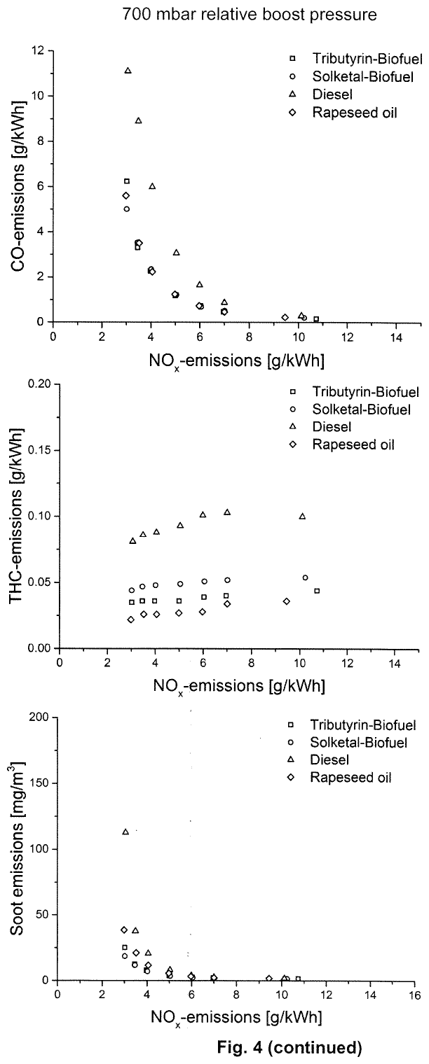

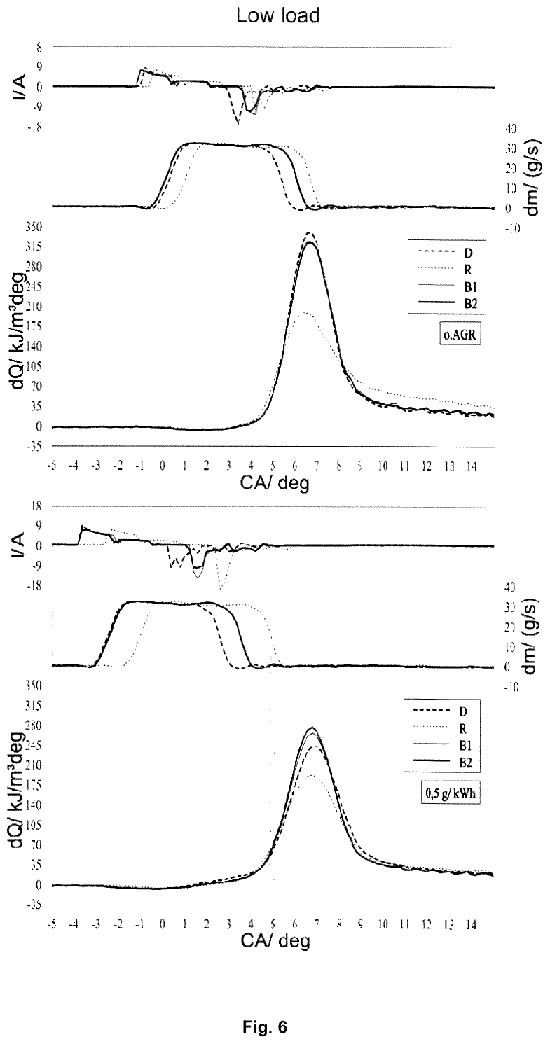

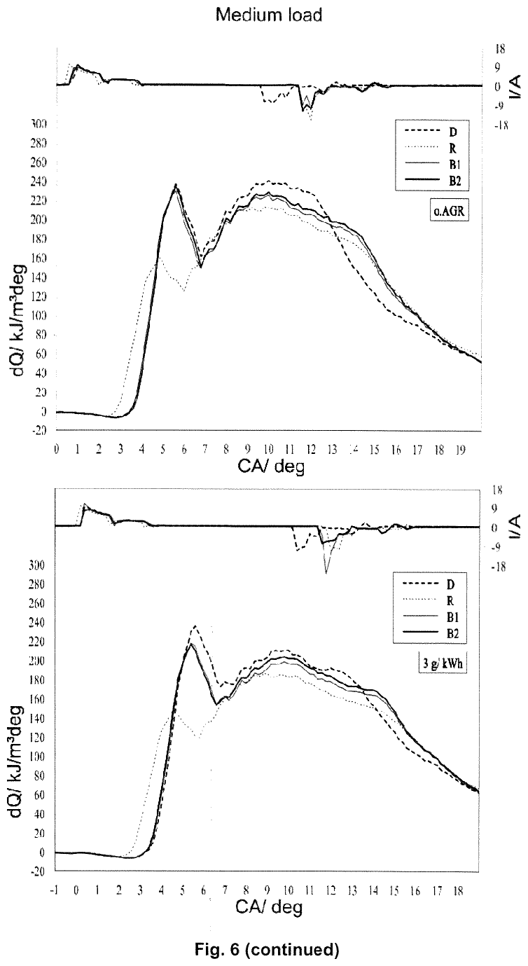

To investigate the emission characteristics, the fuel consumption and the air/fuel balance, the exhaust gas recirculation rate was tested at 200 and 700 mbar relative boost pressure (see FIG. 4). A specific NO_{R}-emission value was adjusted for every measurement as reference point to determine every other emission parameter of the formulated biofuels, diesel and pure rapeseed oil. While both biofuels lead to slightly higher CO-emissions than diesel at low boost pressure, they lead to distinctly lower CO-emissions than diesel at high boost pressure. The same applies to the total hydrocarbon emissions (THC-emissions). By analyzing the results without exhaust gas recirculation, it is also observable that both formulated biofuels possess NOₓ-emissions which are comparable to diesel, which is exceptional for biofuels. Surprisingly, the determination of the soot emission shows that the Solketal and the Tributyrin system, as well as diesel, do not lead to significant soot formation at low boost pressure. The combustion of rapeseed oil, however, leads to increased soot emissions. At higher boost pressure, the formulated biofuels again show better results than diesel. The fuel consumption of the Solketal and the Tributyrin system is, similarly to other biofuels, slightly higher than diesel, but the air/fuel-balance is nearly identical. The investigation of the combustion processes also shows that the formulated biofuels and diesel have very similar combustion properties (see FIG. 6). While the combustion process of pure rapeseed oil is strongly spread at low load conditions and without exhaust gas recirculation due to its high viscosity and surface tension, both formulated fuels and diesel show the same combustion start. With a complete exhaust gas recirculation, the formulated fuels lead to the shortest combustion times because of their high oxygen content.

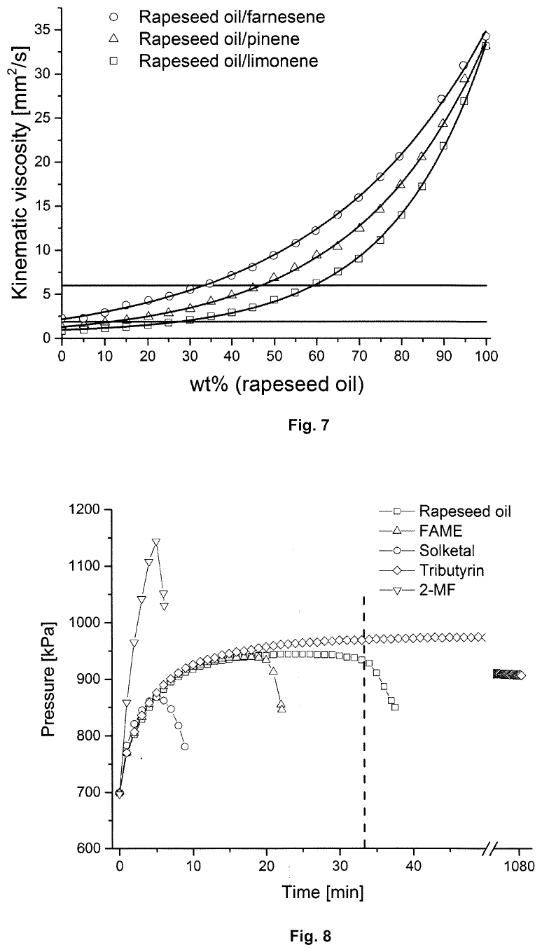

Terpenes are another chemical group obtained from biomass, primarily being constituents of essential oils in plants, which may have suitable properties for the usage as green biofuel components. Therefore, the monoterpenes d-limonene and α-pinene as well as the sesquiterpene farnesene were investigated similarly to the furan derivatives. Every analysed terpene is, identically to the furans, completely miscible with rapeseed oil at room temperature. FIG. 7 shows, analogous to FIG. 1 of the present description, the kinematic viscosities of the binary mixtures of rapeseed oil and one of the terpenes at 40° C., respectively. Although every terpene is distinctly reducing the kinematic viscosity of rapeseed oil, higher amounts are necessary to reach the required viscosity range compared to the furan derivatives. This may be because the kinematic viscosities of the pure terpenes are in the range of 0.8-2.3 mm²/s at 40° C., whereas the furans possess values of about 0.5 mm²/s at 40° C. Nevertheless, the low-temperature performance of these mixtures is enhanced compared to the binary mixtures with furan derivatives. While every investigated terpene is able to keep the mixture monophasic and clear at −20° C. for one month at a specific amount, α-pinene and d-limonene are even able to do so at −40° C. for one month.

### Part B: Experiments Focusing on the Antioxidants

### 1. Preliminary Experiments

To be able to estimate the general stability toward oxidation of the single components of the biofuels, FIG. 8 shows the RapidOxy Measurements of the individual constituents. While pure rapeseed oil surprisingly fulfils the standard, FAME is oxidised distinctly earlier, as expected. Especially solketal's sensitivity toward oxidation is unexpected, since it is oxidised nearly as fast as 2-methylfuran (2-MF), which was chosen as furan derivative for the sake of completeness. Tributyrin, however, is insensitive toward oxidation. The jump in the measuring curve of tributyrin can be explained by the necessary break of the time scale for this experiment. This figure further shows that especially solketal and FAME are prone to oxidation.

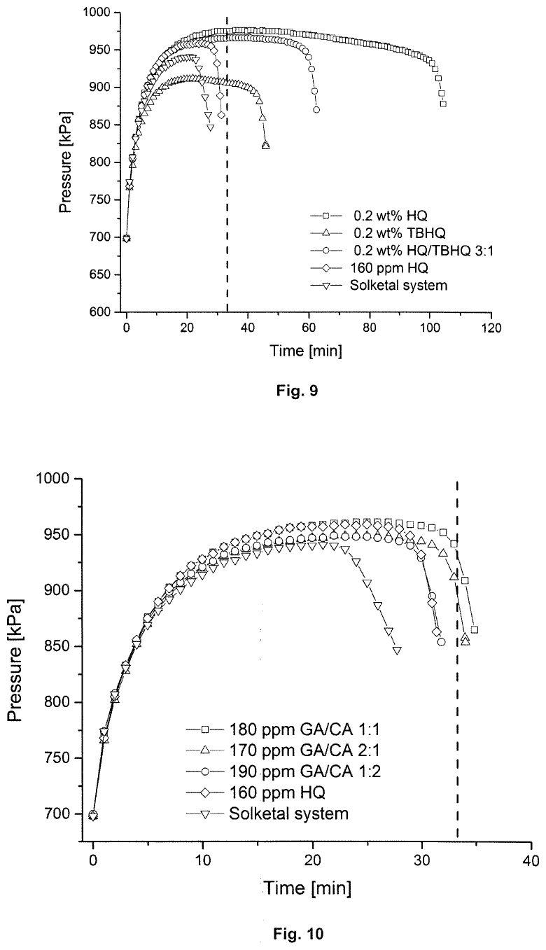

Before measuring the biofuel formulations with natural antioxidants, the effectiveness of synthetic antioxidants regarding the oxidative stability of the solketal system was investigated (see FIG. 9). The solketal system consists of 60 wt.-% FAME, 30 wt.-% rapeseed oil and 10 wt.-% solketal. The tributyrin system consists of 60 wt.-% FAME, 30 wt.-% rapeseed oil and 10 wt.-% tributyrin. By measuring the solketal system, it becomes obvious that additional antioxidants are important to fulfill the standard. By adding 0.2 wt.-% of hydroquinone, one of its derivatives or a mixture thereof, the oxidative stability of the biofuel is distinctly increased. Nevertheless, it needs to be mentioned that 0.2 wt.-% are already very high amounts of additives for fuels, which can only be justified by the low prices of these toxic substances. Therefore, another measurement with 160 ppm hydroquinone was performed, since this amount was used as benchmark for the further investigations with natural antioxidants. Surprisingly, 160 ppm hydroquinone is not enough to fulfill the standard.

After several solubility experiments and RapidOxy measurements with single natural antioxidants as additives for the solketal system, no biofuel formulation was able to fulfil the standard. After that, mixtures of the two most effective natural antioxidants, gallic acid and caffeic acid, were investigated. FIG. 10 shows that there is indeed a synergetic effect between gallic and caffeic acid leading to a compliance with the standard with only 170 ppm of mixtures in a mass ratio of 1:1, as well as 2:1, of gallic to caffeic acid for the solketal system. This means that the amphiphilic properties of solketal enable the usage of hydrophilic, natural antioxidants in biofuels with vegetable oil as one of the main components. Further, these biofuels are competitive with the highly toxic hydroquinones regarding their effectiveness.

FIG. 11 illustrates the influence of the concentration of antioxidants on the oxidative stability of the solketal system. As expected, higher concentrations lead to a better stability with the 1:1 mixture of gallic and caffeic acid being the most effective at low concentrations and pure gallic acid at higher concentrations.

Since these natural antioxidants are more expensive than synthetic antioxidants, the influence of the less expensive ascorbic acid (vitamin C) as an alternative was investigated. Due to the presence of hydrophilic antioxidants like gallic or caffeic acid, ascorbic acid can be solubilised in biofuels without any unsustainable additives. Ascorbic acid is generally not sufficiently soluble in biofuel formulations not containing another hydrophilic antioxidant as defined above or the glycerol derivative.

Regarding the tributyrin system, alkyl gallates were used instead of gallic acid and/or caffeic acid due to their better compatibility. FIG. 12 illustrates the influence of these soluble, less hydrophilic esters of gallic acid on the oxidative stability of the tributyrin system. It can thus be seen that each investigated alkyl gallate is suitable for this application. Concerning the propyl gallate, the amount added to the formulation was varied to investigate the influence on oxidative stability of the mixture. As expected, the higher the concentration of the antioxidant, the better the stability toward oxidation is.

2. Solubility Tests with Glycerol Formal

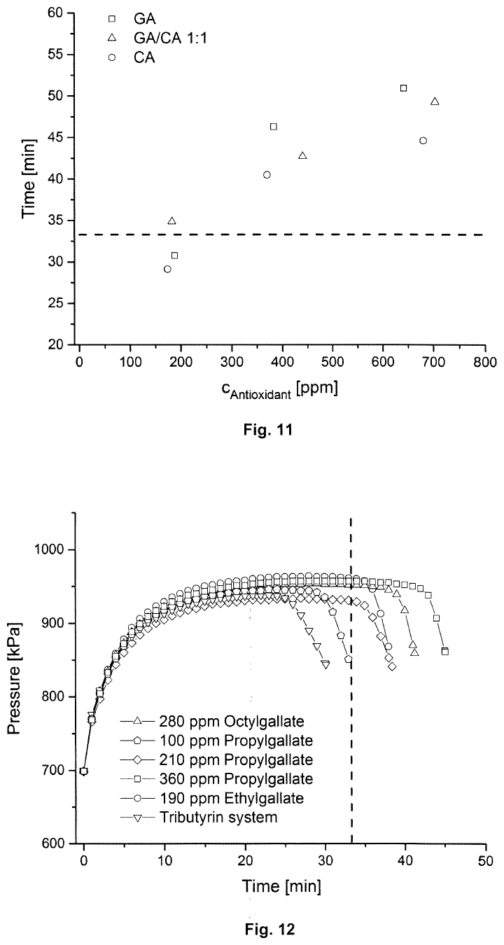

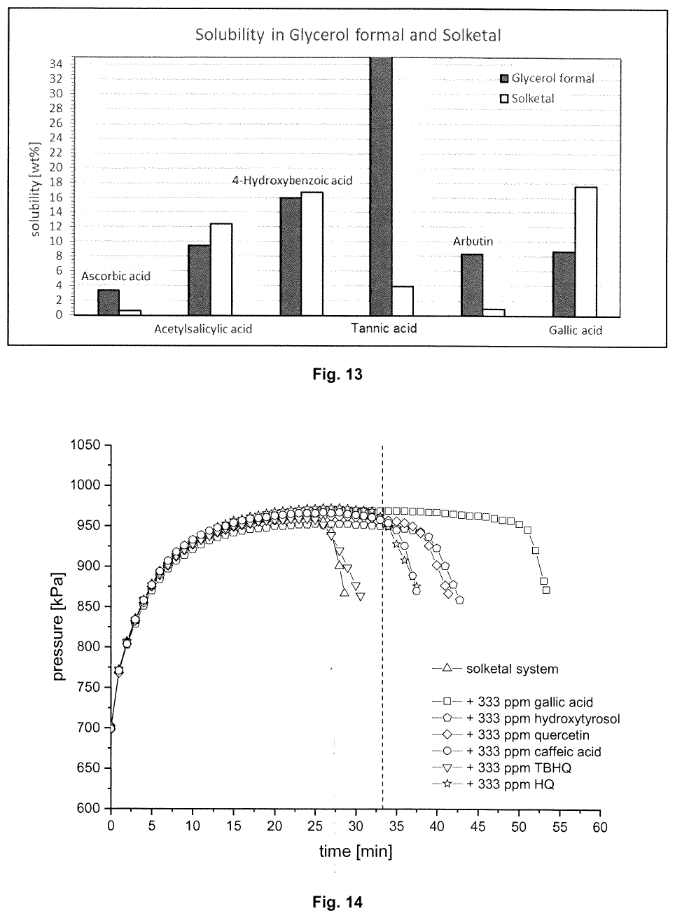

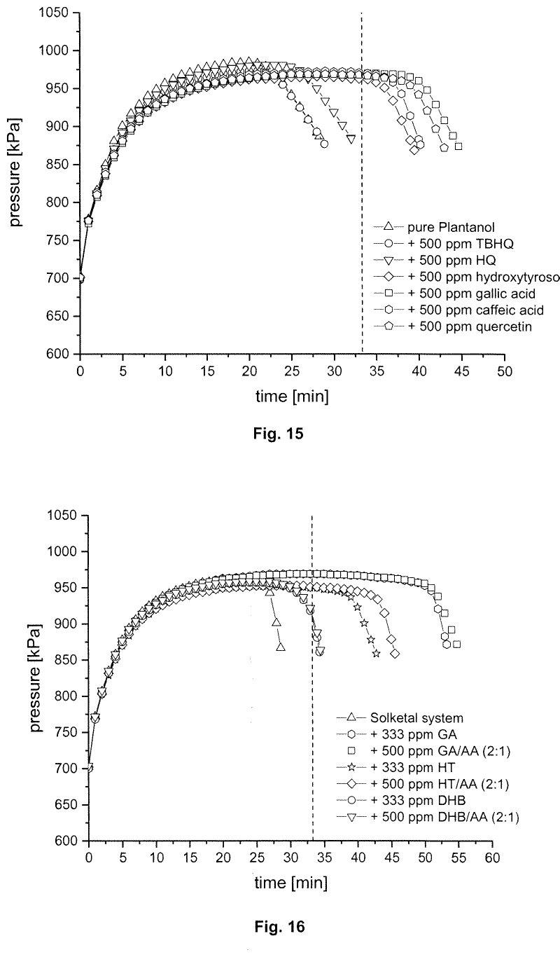

Solubility tests in the more hydrophilic glycerol formal were performed. FIG. 13 shows the solubilities of hydrophilic antioxidants in glycerol formal and solketal, respectively. The solubility of some hydrophilic antioxidants (depicted in FIG. 13) in glycerol formal is several times higher than the one in solketal.

Hence, the usage of glycerol formal enables the implementation of tannic acid, acetylsalicylic acid and 4-hydroxybenzoic acid in the biofuel. Additionally, higher concentrations of ascorbic acid and arbutin in the biofuel are achievable.

It is noteworthy that the tannic acid in glycerol formal has a surprisingly high solubility of over 35 wt.-%. For this reason, experiments with glycerol formal as an extraction solvent were carried out for the purpose of extracting antioxidants. It could be shown that high amounts of antioxidants from tannin-rich oak galls can be extracted by letting oak gall powder stir in glycerol formal at room temperature. Since the extraction solvent already represents a potential fuel component, the diluted extract can be directly added to the fuel to improve the oxidative stability and microbial stability

### 3. Oxidative Stabilities

The oxidative stabilities were measured according to DIN EN 16091 with the so-called RapidOxy-device. For this purpose, the samples were heated up to 140° C. at 700 kPa in an oxygen atmosphere. Thereafter the device measured the pressure with respect to the time. The measurement automatically stopped once a decrease of the pressure of 10% occurred. The time needed for this decrease by 10% is called “induction time” and represents a characteristic quantity for the oxidative stability of a fuel. The quantity “ppm” (parts per million) in the present experimental examples refers to a molar ratio (n/n), if not stated otherwise.

### 3.1 Natural, Hydrophilic Antioxidants in Rapeseed Oil/Biodiesel Mixtures

The effect of certain natural antioxidants on the oxidative stability of a biofuel mixture consisting of 63/27/10 biodiesel (FAME)/rapeseed oil/solketal was investigated. For comparison, the commercially used and synthetic antioxidants hydroquinone (HQ) and tert-butylhydroqinone (TBHQ) were measured as well.

The pure biofuel system (triangle) does not fulfil the European standard (c.f. dashed line in FIG. 14) while the addition of 330 ppm of gallic acid (GA), caffeic acid (CA), hydroxytyrosol (HT), hydroquinone (HQ) and quercetin, respectively, are enough to make the biofuel fulfil the standard according to EN 14214. Additionally, all shown natural antioxidants are evidently either as potent as the synthetic antioxidants HQ and TBHQ or are leading to significantly better results. It is noteworthy that HQ is of synthetic origin and exhibits carcinogenic properties and a high aquatic toxicity. In contrast, the natural antioxidants like gallic acid and hydroxytyrosol are non-hazardous and even used in beverages or used as an additive in food industry.

3.2 with Plantanol as Biofuel

It was shown above that hydrophilic antioxidants can be implemented into the biofuel after dissolving them in glycerol derivatives to increase the oxidative stability of the biofuel. As a proof of concept, analogous experiments were carried out with the biofuel “Plantanol” from industry. The Plantanol represents a diesel-fuel produced by the company Handelshaus Runkel and mainly consists of refined rapeseed oil and hydrotreated vegetable oils (HVO). The samples were prepared by dissolving the respective antioxidants in solketal. Thereafter, the solution was added to the Plantanol so that the final composition contained 500 ppm(n/n) of the antioxidant and 1 wt.-% of solketal.

FIG. 15 illustrates the induction times of pure Plantanol and the ones of mixtures containing 1 wt.-% of Solketal and 500 ppm (n/n) of the respective antioxidant. Pure Plantanol did not fulfill the standard according to EN 14214 as the induction time is below 33.3 minutes (cf. dashed line in FIG. 15). The addition of gallic acid, quercetin, hydroxytyrosol or caffeic acid leads to an increase of the induction time by 10-15 minutes which is sufficient to meet the criteria of EN 14214 with respect to the oxidative stability. This represents a significant stabilization by the addition of rather low amounts of antioxidants to the Plantanol and, thereby, shows that the concept can be applied to different types of biofuels, too. Further, the big difference between the synthetic antioxidants HQ/TBHQ and the natural antioxidants GA, CA, HT and Quercetin should be stressed as the standard according to EN 14214 was not reached upon addition of 500 ppm of the synthetic antioxidants used in industry (InaCHEM “inaAOX-die natürliche Stabilisierung von Biodiesel”, https://www.inachem.de/de/inaAOX).

### 3.3 Potential Use of Vitamin C in Biofuels

Vitamin C (ascorbic acid) represents a cheap and commercially available antioxidant that is widely used in food industry. The direct addition of this antioxidant to the hydrophobic biofuel is not possible as it is too hydrophilic. An implementation of the antioxidant, however, is possible when using amphiphilic molecules like the glycerol derivatives solketal and glycerol formal. Since the effect of vitamin C, as reported above, seemed to highly vary depending on the investigated antioxidant-system, 2:1 mixtures of a potent antioxidant and vitamin C were prepared and added to the same biofuel system discussed above in point 2.1 (“solketal system”: 63 wt.-% FAME, 27 wt.-% rapeseed oil and 10 wt.-% of Solketal).

As already mentioned in chapter 2.3.1, the pure biofuel (triangle) without any antioxidant does not fulfill the European standard with an induction time of ˜28 mins. The addition of 333 ppm of DHB, GA or HT, however, leads to a stabilization above the minimum of EN 14214. Different effects are observable when adding 167 ppm of vitamin C to the same antioxidant-containing mixtures. The addition of vitamin C to the system containing DHB (cf. curves with circles/upside-down triangles) has no effect on the overall stability of the system while the vitamin C leads to a distinct increase of the oxidative stability in the HT system (cf.curves with stars/rhombs) and GA system (cf. curve with octagons/squares).

To sum it up, it could be shown that the addition of vitamin C to certain antioxidant-solketal-mixtures can be used to enhance the oxidative stability of the biofuel. However, the effectivity of vitamin C is still lower than the ones of the other potent antioxidants like gallic acid or hydroxytyrosol. The addition of 167 ppm of vitamin C to 333 ppm of HT, for example, increases the oxidative stability significantly but this mixture would still be less effective than 500 ppm of HT. The potential use of vitamin C could nevertheless be justified by the cheaper price (bulk prices: hydroxytyrosol: 720 €/kg (Wacker), vitamin C: <10 €/kg).

### 3.4 Oak Gall Extracts

As already stated above, the solubility of tannic acid in glycerol formal was surprisingly high (solubility >35 wt.-%). This led to the attempt of extracting antioxidants from tannin-rich oak galls with glycerol formal as extraction solvent. After the successful extraction, the dark brown extract was diluted with glycerol formal and solketal and added to the biofuel system discussed in points 2.1 and 2.3 above (“solketal system”). RapidOxy-measurements were then carried out to measure the oxidative stability.

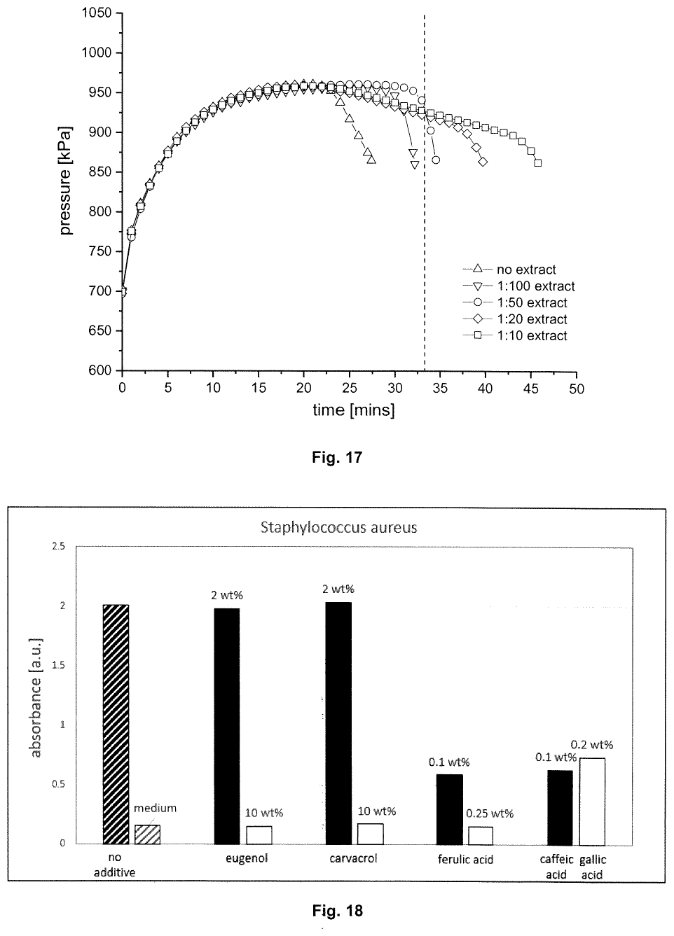

It could be shown that it is possible to extract potent antioxidants from oak galls that increase the oxidative stability of the biofuel system (cf. FIG. 17). The addition of a 1:50-diluted extract is sufficient to make the biofuel fulfill the standard according to EN 14214. It should be noted that 10 wt.-% of the diluted extract was always added to the system, i.e. the dilution based on the total composition is 10 times higher than the one of the used extract. In case of the 1:50 diluted extract, for example, it means that a 1:500 dilution, i.e. 0.2 wt.-% of the extract were sufficient to increase the oxidative stability above the EN 14214 limit. Since the extraction solvent is a potential fuel component, the extract can be directly added to the biofuel without any further work-up which represents an advantageous property with respect to a potential industrial application.

Aside from the antioxidants mentioned above, tyrosol, xanthohumol, arbutin, acetylsalicylic acid and tannic acid were successfully solubilized in the biofuel with the help of glycerol derivatives.

### Part C: Experiments Focusing on the Antimicrobial Action of the Antioxidants

### 1. Background and Methods

The growth of microbes in the fuel is one of the main problems of biofuels, as set out above. The aim of the experiments was to investigate the bacterial growth in the biphasic biofuel/water system to see how the addition of an antimicrobial additive to the biofuel has an impact on the microbial growth in the aqueous bacteria solution. For this purpose, the so-called “broth dilution” method was modified and applied to the biphasic (biofuel+additive)/(water+bacteria) system.

### 2. Broth Dilution

This method represents a standard test for the investigation of bactericidal substances (e.g. antibiotics). At first, bacteria are incorporated in water that contains a nutrient medium (e.g. blood or yeast extracts). The potential antimicrobial agents are then added to the bacteria solution and the mixture is incubated over night at a certain temperature.

The concentration of bacteria can be measured by means of photometric spectroscopy as the presence of bacteria in a solution lead to turbidity. The higher the turbidity, the more bacteria are present in the solution. Depending on the antimicrobial activity of the additive, the turbidity of the samples can increase (=bacteria grow), exhibit a lower increase of the turbidity (=partial inhibition of bacterial growth) or not increase at all (=complete inhibition of bacterial growth). In some cases, the turbidity even decreases (=bacteria die).

### 3. Modified “Broth Dilution”-Method

The above-mentioned method was modified and applied to the biofuel/water system. For this purpose, there was one type of gram-negative (Escherichia coli) and gram-positive bacteria (Staphylococcus aureus) incorporated in each aqueous medium. The so-called “LB-medium” (lysogeny broth) was used as the nutrient medium. The biofuel (with and without additive) was then added to the bacteria solution leading to a phase separation of the biofuel (top) and aqueous medium (bottom).

The samples were incubated in a so-called incubator shaker, to ensure a good mixing of the two phases. Thereafter, the samples were taken out of the incubator and it was waited until complete phase separation occurred (˜30 minutes). Lastly, the aqueous phase was transferred and measured photometrically at a wavelength of A=600 nm.

It was found that, upon mixing, the biofuel itself did not lead to turbidity of the water. Thus, the turbidity of the aqueous phase solely arises from the bacteria's presence in the water. Depending on the magnitude of the turbidity, it can be concluded whether and how the addition of a certain compound to the biofuel affects the bacterial growth in the aqueous medium.

4. Tests with the Biofuel “Plantanol”

The microbial growth in the fuel Plantanol has been reported above. For this purpose, different concentrations of antimicrobial substances were added to the biofuel and the effect of these substances on the turbidity of the samples was investigated. On the one hand, hydrophobic, biofuel-soluble bactericides were used (Eugenol, Carvacrol) and on the other hand hydrophilic, biofuel-insoluble substances (caffeic acid, gallic acid, ferulic acid) were used. The glycerol derivative solketal was used to make the hydrophilic substances soluble in the biofuel.

The first antimicrobial tests with Plantanol as biofuel are illustrated in FIG. 18. Before incubation, the bacteria suspension exhibited an absorbance of 0.15 (cf. “medium”). After the incubation with Planatanol, the absorbance rose up to 2.0 which represents a distinct increase in bacteria concentration. Additionally, it could be shown that 2 wt.-% of Carvacrol and Eugenol had no effect on the bacterial growth while 10 wt.-% of these substances completely inhibited the growth. Further, the bacterial growth was distinctly reduced upon addition of significantly lower amounts (0.1-0.25 wt.-%) of the natural antimicrobial agents ferulic acid, gallic acid and caffeic acid. A complete inhibition was achieved when adding 0.25 wt.-% of ferulic acid.

These results represent a significant antimicrobial effect of the hydrophilic antioxidants like ferulic acid compared to the bactericides eugenol and carvacrol. The latter is a biocide (Kordali, S. et al., Bioresource Technology 2008, 99(18), p. 8788-8795) used in agriculture as an insecticide while eugenol represents a germicide (and anesthetic) used in dentistry (Markowitz, K., et al, Oral Surg Oral Med Oral Pathol 1992, 73:6, p. 729-737). These well-known substances, however, have to be added in 40 times higher amounts than ferulic acid to achieve the same effect. The reason for this observation is assumed to be the difference in the water solubility of eugenol and carvacrol and their partition coefficient, respectively. Only small amounts of carvacrol and eugenol are dissolvable in water while the ferulic acid is very well water-soluble (at neutral pH). According to the supplier, the Plantanol already contains a mineral bactericide in it which makes the result of low amounts of ferulic acid even more remarkable. The negligible effect of the mineral bactericide in the tests is assumed to due to the low water solubility as well. Hence, the bactericide added by the supplier does not seem to have an effect on the aqueous phase in which bacteria and fungi actually grow.

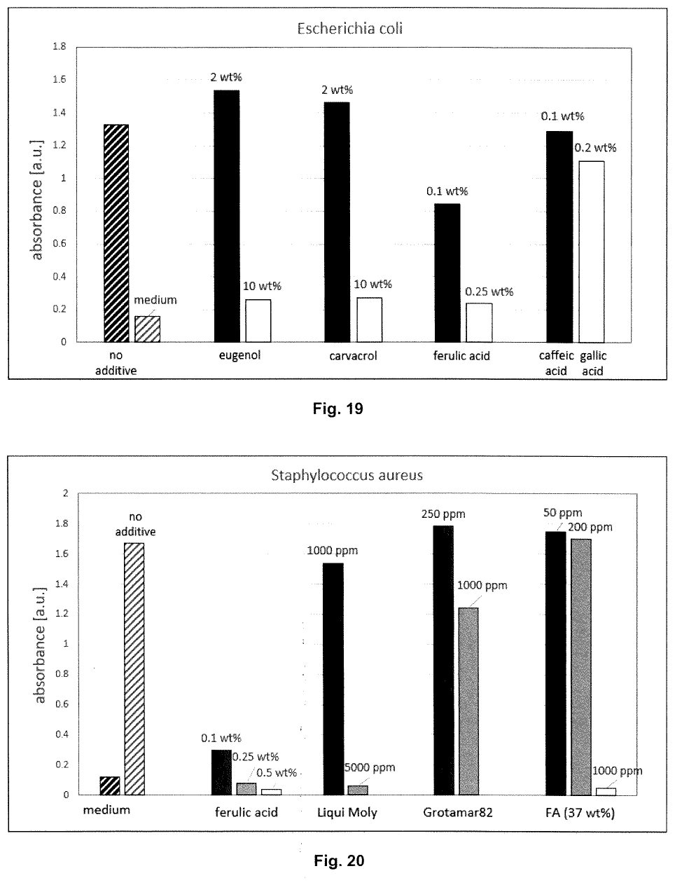

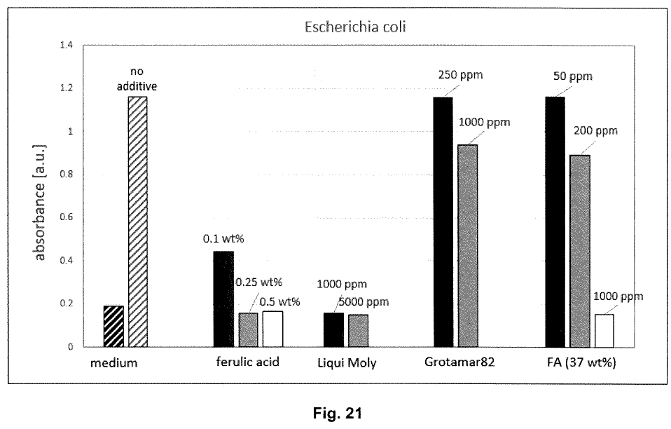

Analogous tests with gram-negative E.-coli bacteria showed a similar trend with respect to the additives (cf. FIG. 19). The only difference, however, is that 10 wt.-% of carvacrol/eugenol as well as 0.25 wt.-% of ferulic acid did not completely inhibit the bacterial growth anymore. Instead, they distinctly reduced it. Additionally, caffeic acid and gallic acid seem to have a smaller effect on the E.-coli bacteria than they had on the Staphylococcus aureus. Nevertheless, small amounts of ferulic acid in a lower ppm were as effective as 10 wt.-% of carvacrol and eugenol again.

Similar results were obtained when using limonene, phenoxyethanol, as well as the hydrophilic substances sorbic acid, caffeic acid, 4-hydroxybenzoic acid, methyl 4-hydroxybenzoate and 2-methyl-4-isothiazolin-3-one that were solubilised in the biofuel by the glycerol derivative solketal.

5. Comparative Tests with the Products “Grotamar®82” and Liqui Moly—“Marine Diesel Protect”

The bactericide tests described above were carried out with two industrial products for comparison.

The first product was Grotamar®82, which is an “anti-diesel-bug”-product sold by Schülke & Mayr GmbH (Norderstedt, Germany). It contains a formaldehyde-precursor that releases formaldehyde when getting in contact with water. The use of this product by the general public was prohibited in December 2018 due to formaldehyde being suspected to cause genetic defects.

The second product is “Marine Diesel Protect” sold by Liqui Moly GmbH (Ulm, Germany). It contains the biocide benzisothiazolinone, a common preservative in paints, cleaning products and cosmetics. Additionally, 10-20 wt % of methyl salicylate is present in the product to increase the storage stability of the diesel. Methyl salicylate represents a well-known antioxidant and flavoring (e.g. in liniments or chewing gum) but has also been shown to have antimicrobial activity. Therefore, it could be part of the antimicrobial effect of the Liqui Moly-Product as well.

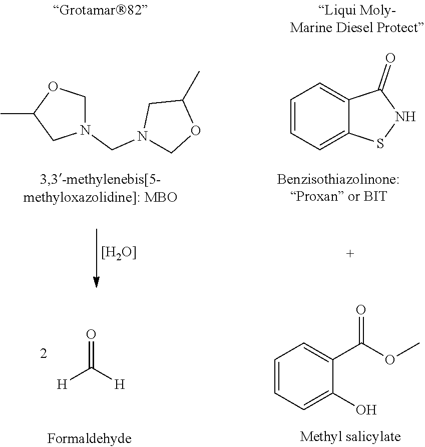

The above scheme shows antimicrobial agents used in the industrial “anti-diesel-bug”-products sold in industry. In Grotamar®82 (left), 3,3′-methylenebis[5-methyloxazolidine] (MBO) is used. A hydrolysis of this compound leads to the release of formaldehyde. A mixture of benzisothiazolinone and methyl salicylate is used in “Marine Diesel Protect” (right).

5.1 Bactericide Tests with Staphylococcus aureus

The chosen concentrations for Grotamar82 and Liqui Moly were the ones recommended by the manufacturer. For both products, there is a recommended concentration for prevention of diesel bug as well as a recommended “shock dosage” in case of an already existing microbial contamination. 1000 ppm of Grotamar82 as well 5000 ppm of the product by Liqui Moly are recommended as a “shock dosage” while 250 ppm and 1000 ppm are recommended to achieve an effective protection against diesel bug.

Additionally, formaldehyde was added to the Plantanol as the kinetics of the hydrolysis of MBO (cf. the above scheme) in Grotamar82 were not known. Grotamar82 contains about 20% of MBO, according to the manufacturer. Thus, a complete hydrolysis of the MBO in 250 ppm and 1000 ppm Grotamar82 would result in the production of 50 ppm and 200 ppm of formaldehyde respectively. Further, it should be noted that the MBO will be degraded into about 30% of formaldehyde upon hydrolysis which is comparable to the concentration of formaldehyde in a concentrated aqueous solution (37 wt %).

The incubation of pure Staphylococcus aureus medium with Plantanol leads to an increase of the turbidity from 0.12 to an absorbance value of over 1.6 (cf. FIG. 20). The addition of ferulic acid dissolved in solketal leads to a significant decrease of bacterial growth. Upon addition of 0.1 wt % ferulic acid, the bacterial growth drastically decreases while 0.25 wt % and 0.5 wt % of ferulic acid even led to absorbance values below 0.12. Thus, these concentrations were sufficient to kill the bacteria.

The recommended amount of the Liqui-Moly-product for a prevention of microbial contamination (1000 ppm) had almost no effect on microbial growth while the effect of 5000 ppm (“shock dosage”) was comparable to the one achieved by the addition of higher amounts of ferulic acid (>0.25 wt %) in solketal.

The addition of Grotamar82 had either no effect on the microbial growth or only slightly inhibited the growth when used at concentrations of 250 ppm and 1000 ppm. A similar effect could be observed upon addition of 50 ppm and 200 ppm of formaldehyde (FA). This observation indicates that the rather low effect of the Grotamar82 in the performed tests are unlikely to derive from the slow hydrolysis of the MBO. Moreover, higher concentrations seem to be necessary to achieve a complete inhibition of the bacterial growth as no bacteria were growing after adding 1000 ppm of formaldehyde.

These results show that the effect of ferulic acid in solketal is either comparable to the “shock dosages” of an industrial product (Liqui Moly) or even better (Grotamar82). Furthermore, it gives important information about the comparability of the presently used bactericide tests and the “reality” of microbial growth in fuels. 1000 ppm Grotamar82, for instance, had only a slight effect on the bacterial growth in the tests. According to the manufacturer, however, 1000 ppm are recommended to purge the fuel tank from an already existing microbial contamination. Thus, the self-developed tests seem to be carried out at rather harsh conditions with higher concentrations of bacteria and bigger amounts of water. Thus, if a bactericidal/bacteriostatic compound works well in the developed bactericide tests, it should also work well in fuel tanks to prevent microbial contamination.

5.2 Bactericide Tests with Staphylococcus aureus

Very similar trends were observed when using the same concentrations of the respective additives with the gram-negative E.-coli as a bacteria culture. 250 ppm and 1000 ppm of Grotamar82 were as effective as 50 ppm and 200 ppm of formaldehyde. Further, 0.1 wt % of ferulic acid in solketal significantly decreased microbial growth. No growth of bacteria was observable when using 0.25 wt %/0.50 wt % of ferulic acid, 5000 ppm of the Liqui-Moly-product or 1000 ppm of formaldehyde. In contrast to the tests with Staphylococcus aureus, 1000 ppm of the “Marine Diesel Protect” (Liqui Moly) showed the same effect as 5000 ppm of the “anti-diesel-bug”-product indicating a higher effectivity against the E.-coli bacteria.

### 5.3 Discussion of the Comparative Tests

It was found that different amounts of the glycerol derivatives are preferably used to solubilize the respective antioxidants/bactericides. For example, a rather low amount of <0.5 wt % solketal would be sufficient to solubilize 500 ppm of gallic acid in Plantanol while up to 10 wt % of solketal were found preferable when using 0.1 wt % of caffeic acid in Plantanol. Higher concentrations than 10 wt % were not required.

It should be noted that the industrial products Grotamar82 and “Marine Diesel Protect” do not only consist of pure biocides. Instead, they contain up to 20% of MBO (Grotamar82) and up to 24% of benzisothiazolinone/methyl salicylate (Liqui Moly) which are the active antimicrobial agents. The other ingredients of these product include solvents (typically C₁₀-C₁₃ hydrocarbons), cetane boosters (Ethylhexylnitrate), lubricants etc. as can be seen from the safety data sheets of the respective products. Thus, the investigated bactericides of the patent should be compared with the amount of active antimicrobial agents in the product and not the whole formulation. Therefore, the presently used bactericides such as ferulic acid are similarly effective as the bactericides used in the Liqui Moly product.

However, natural bactericides like ferulic acid have several advantages compared to the bactericides presently used in industry, such as MBO and benzisothiazolinone. In particular, they are non-synthetic and less hazardous compared to the corrosive, aqua-toxic (and possibly carcinogenic) compounds like formaldehyde or benzisothiazolinone (BIT). Furthermore, unlike BIT, they do not contain any nitrogen or sulfur atoms. Compounds containing these heteroatoms are unfavorable during combustion as their oxidation in the engine typically lead to the formation of sulfur oxides and NO_{R}-gases.

In summary, the compositions of the present invention, when used as biofuels, enable the use of pure triglyceride oils as one of the main components even when only containing compounds adhering to green chemistry. Further, the glycerol derivatives Solketal and Tributyrin, which can be produced by green syntheses from glycerol, can successfully be used in these formulations. The amount of necessary additive is minimized to merely a few weight percent. Therefore, a huge amount of rapeseed oil no longer needs to be processed to biodiesel and the by-product of the FAME production, namely glycerol, can be further processed to a fuel component and used along with the FAME. Finally, the formulated biofuels are nearly completely based on oil which can be derived from natural and renewable resources such as rapeseed oil. The results of the engine tests show that the compositions of the present invention exhibit fuel properties which are comparable to diesel or even better than diesel concerning their emission properties and combustion properties.

The mixture of the present invention is one application which is envisaged for direct use by consumers, such as farmers, who merely have to add their locally produced vegetable oil, such as rapeseed oil, thereby not only providing a more economical but also more environmentally viable fuel.

Furthermore, the natural antioxidants used in the present invention lead to surprisingly enhances antimicrobial effects, even at low concentrations.

1. A composition, mixture or formulation comprising:
one or more C₈₋₂₂ fatty acid triglycerides and/or one or more C₈₋₂₂ fatty acid C₁₋₆ alkyl esters,
a glycerol derivative other than C₈₋₂₂ fatty acid triglycerides, and
one or more natural antioxidants.

2. A composition according to claim 1, wherein the composition comprises:
one or more C₈₋₂₂ fatty acid triglycerides,
one or more C₈₋₂₂ fatty acid C₁₋₆ alkyl esters,
a glycerol derivative other than C₈₋₂₂ fatty acid triglycerides, and
one or more natural antioxidants.

3. The composition according to claim 2, containing 10% by weight or more of the C₈₋₂₂ fatty acid triglycerides based on the total weight of the composition and 35% by weight or more of the C₈₋₂₂ fatty acid C₁₋₆ alkyl esters based on the total weight of the composition.

4. A mixture according to claim 1, wherein the mixture comprises:
one or more C₈₋₂₂ fatty acid C₁₋₆ alkyl esters,
a glycerol derivative other than C₈₋₂₂ fatty acid triglycerides, and
one or more natural antioxidants,
wherein the mixture does not contain 10% by weight or more of C₈₋₂₂ fatty acid triglycerides based on the total weight of the mixture.

5. A formulation according to claim 1, wherein the formulation comprises:
one or more C₈₋₂₂ fatty acid triglycerides,
a glycerol derivative other than C₈₋₂₂ fatty acid triglycerides, and
one or more natural antioxidants.

6. The formulation according to claim 5, wherein the formulation is a lubricant formulation or a lubricant base oil.

7. The composition, mixture or formulation claim 1, further comprising one or more selected from
(i) a furan derivative which is a compound comprising at least one furan moiety or tetrahydrofuran moiety and which comprises from 5 to 15 carbon atoms and from 1 to 10 heteroatoms selected from N, O and S, and
(ii) a terpene derivative selected from monoterpenes and sesquiterpenes and derivatives thereof.

8. The composition, mixture or formulation of claim 1, wherein the glycerol derivative other than C₈₋₂₂ fatty acid triglycerides is selected from cyclic ethers of glycerol comprising from 4 to 7 carbon atoms.

9. The composition, mixture or formulation of claim 1, wherein the glycerol derivative other than C₈₋₂₂ fatty acid triglycerides comprises one or more compounds of the following formulae (A-I) and/or (B-I) 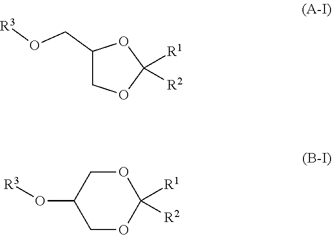
wherein R¹, R² and R³ are each independently selected from hydrogen and C₁₋₁₀ alkyl groups.

10. The composition, mixture or formulation according to claim 9,
wherein the glycerol derivative other than C₈₋₂₂ fatty acid triglycerides comprises one or more compounds of the following formulae (A-II) and (B-II) 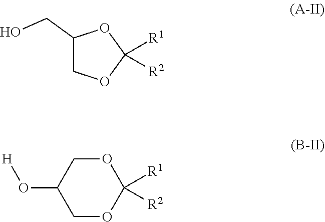
wherein R¹ and R² are either both hydrogen atoms or both methyl groups.

11. The composition, mixture or formulation of claim 1, wherein the one or more natural antioxidants is/are selected from gallic acid, protocatechuic acid, p-coumaric acid, o-coumaric acid, caffeic acid (cis and trans), carnosol, carnosic acid, curcumin, rosmanol, rosmadial, rosmaridiphenol, rosmarinic acid (cis and trans), chlorogenic acid, ferulic acid, ethyl gallate, propyl gallate, octyl gallate, tocopherols such as α-tocopherol, β-tocopherol, γ-tocopherol and δ-tocopherol, epicatechin, quercetin, epicatechin gallate, epigallocatechin gallate, eugenol, carvacrol, safrole, thymol, ascorbic acid, ascorbyl palmitate, resveratrol, syringic acid, sinapinic acid, thymol, vanillic acid, p-hydroxybenzoic acid, p-hydroxybenzaldehyde, hydroxytyrosol, tyrosol, xanthohumol, arbutin, acetyl salicylic acid, tannic acid, tannins such as corilagin, catechol, myricetin, isoeugenol, sesamol, aesculetin, sorbic acid, 4-hydroxybenzoic acid, methyl 4-hydroxybenzoate, 2,3-dihydroxybenzoic acid, 2,4-dihydroxybenzoic acid, 2,5-dihydroxybenzoic acid, 2,6-dihydroxybenzoic acid, 3,4-dihydroxybenzoic acid and 3,5-dihydroxybenzoic acid; including any esters of these compounds wherein a COOH group is replaced by a —COOR^{G} group, wherein R^{G} is selected from linear or branched C₁₋₂₀-alkyl or linear or branched C₁₋₂₀-alkenyl, wherein the C₁₋₂₀-alkyl or C₁₋₂₀-alkenyl may be substituted with one or more —OH.

12. The composition, mixture or formulation of claim 1, wherein the one or more natural antioxidants is/are
a) one or more of gallic acid, quercetin, tannins and hydroxytyrosol, and/or
b) one or more of ferulic acid, sorbic acid, 4-hydroxybenzoic acid, 4-hydroxybenzoic acid and methyl 4-hydroxybenzoate.

13. An antioxidant composition comprising one or more glycerol formal(s) and one or more natural antioxidants as set out in claim 11 or 12, characterized in that the antioxidant composition comprises 20 wt-% or more of one or more glycerol formal(s) based on the total weight of the composition.

14. The antioxidant composition according to claim 13, wherein the antioxidant composition comprises one or more glycerol formal(s) and tannic acid, characterized in that the composition comprises 50 wt-% or more of one or more glycerol formal(s) based on the total weight of the composition.

15. The antioxidant composition according to claim 13, wherein the antioxidant composition is a plant extract.

16. The formulation of claim 5, wherein the formulation does not contain 35% by weight or more of C₈₋₂₂ fatty acid C₁₋₆ alkyl esters based on the total weight of the formulation.

17. The composition, mixture or formulation of claim 7, wherein the terpene derivative has the molecular formula C₁₀H₁₆ or C₁₅H₂₄.

18. The composition, mixture or formulation of claim 9, wherein the glycerol derivative other than C₈₋₂₂ fatty acid triglycerides consists of one or more compounds of formulae (A-I) and/or (B-I).

19. The composition, mixture or formulation of claim 10, wherein the glycerol derivative other than C₈₋₂₂ fatty acid triglycerides consists of one or more compounds of formulae (A-II) and/or (B-II).

20. The antioxidant composition of claim 15, wherein the plant extract is an extract of oak gall.
